(19) United States
(12) Patent Application Publication
(10) Pub. No.: US 2025/0055340 A1
(43) Pub. Date: Feb. 13, 2025

(54) STACKED-WINDING STATOR ELECTRICAL MACHINE

(71) Applicant: SAIETTA GROUP PLC, Oxfordshire (GB)

(72) Inventor: Christopher LINES, Oxfordshire (GB)

(21) Appl. No.: 18/720,134

(22) PCT Filed: Dec. 16, 2022
(86) PCT No.: PCT/GB2022/053268

§ 371 Date: Jun. 14, 2024

(30) Foreign Application Priority Data
Dec. 16, 2021 (GB) 2118274.6

(51) Int. Cl. H02K 3/28; H02K 1/18

(52) U.S. Cl. CPC H02K 3/28; H02K 1/182; H02K 2203/09

(57) ABSTRACT

A stacked-winding stator for an axial flux electrical machine is provided that is configured for use with a multi-phase power supply. The stacked-winding stator comprises a first stator portion comprising a first plurality of conductive coils and a second stator portion comprising a second plurality of conductive coils. Each conductive coil in the first plurality of conductive coils and the second plurality of conductive coils comprises at least one pair of active sections and each active section extends in a generally radial direction substantially perpendicular to an axis of rotation of the electrical machine. The first stator portion and the second stator portion are axially aligned and each comprise spaces between adjacent active sections for receiving flux guides. the spaces in the first stator portion being circumferentially aligned with the spaces in the second stator portion.

### TECHNICAL FIELD

The invention relates to stacked-winding stator electrical machines, and in particular to a stacked-winding stator assembly for a stacked-winding yokeless stator axial flux electrical machine and other components thereof.

### BACKGROUND

Electrical machines, including electric motors and electric generators, are already very widely used. However, concerns over our reliance on and the pollution caused by the fossil fuels that power internal combustion engines is creating political and commercial pressures to extend the use of electrical machines to new applications, and to expand their use in existing ones. Electrical machines are increasingly being used in vehicles, such as electric cars, motorbikes, boats and aircraft. They are also used in energy generation applications, for example generators in wind turbines.

In order to meet the needs of these applications, it will be necessary to design electrical machines that have both suitable performance properties, such as speed and torque, and high efficiency. The efficiency of electrical machines is critically important in almost all applications: it can, for example, both increase an electric vehicle's range and decrease the required battery capacity. Decreasing the required battery capacity can in turn decrease the weight of the vehicle, which leads to further efficiency gains. As well as electrical efficiency, an efficient use of materials is also an important concern. Electrical machines should preferably use as little material (e.g. copper) as possible, for both environmental and cost reasons but also to save weight (which again helps improve the efficiency and range of electrical machines and vehicles).

One known type of electrical machine is the axial flux machine. As the name suggests, the direction of the lines of magnetic flux that are cut during the operation of an axial flux machine is parallel to the axis of rotation of the machine. This is in contrast to radial flux machines, in which the direction of the lines of magnetic flux that are cut during the operation of the machine is perpendicular to the rotation axis of the machine. While radial flux machines are more common, axial flux machines have been used for some applications where their form factor (a relatively small axial extent) and performance properties (such as a high torque to weight ratio) are appreciated.

One example of a yokeless axial flux machine is described in GB Patent Application GB2580918. This document discloses a conductive coil for a yokeless axial flux electrical machine stator with distributed windings, a stator comprising a plurality of such coils, a yokeless axial flux electrical machine comprising the stator, and a method of manufacturing a stator. The conductive coil comprises a first active section and a second active section, each active section extending in a generally radial direction substantially perpendicular to an axis of rotation of the electrical machine and comprising a plurality of winding turn portions stacked parallel to the axis of rotation such that a cross-section perpendicular to the radial direction of each active section is elongate with a major dimension parallel to the axis of rotation. The second active section is pitched apart in a circumferential direction and axially offset from the first active section. This document also discusses an example of a stacked-winding stator comprising two stator portions, which the present inventors have developed upon.

### SUMMARY OF THE INVENTION

Embodiments described herein provide a conductive coil and a stator for an axial flux machine comprising a plurality of conductive coils which provide for high machine efficiencies, ease of manufacture and good heat conduction from the coils to the stator housing which aids cooling.

Throughout this disclosure, unless otherwise qualified, terms such as “radial”, “axial”, “circumferential” and “angle” are used in the context of a cylindrical polar coordinate system (r, ϑ, z) in which the direction of the axis of rotation of the electrical machine is parallel to the z-axis. That is, “axial” means parallel to the axis of the rotation (that is, along the z-axis), “radial” means any direction perpendicular to the axis of rotation, an “angle” is an angle in the azimuth direction ϑ, and “circumferential” refers to the azimuth direction around the axis of rotation.

Terms such as “radially extending” and “axially extending” should not be understood to mean that a feature must be exactly radial or exactly parallel to the axial direction. To illustrate, while it is well-known that the Lorentz force experienced by a current carrying conductor in a magnetic field is at a maximum when the direction of the current is exactly perpendicular to the direction of the magnetic flux, a current carrying conductor will still experience a Lorentz force for angles less than ninety degrees. Deviations from the parallel and perpendicular directions will therefore not alter the underlying principles of operation.

The invention is defined in the independent claims to which reference should now be made. Preferred features are set out in the dependent claims.

According to a first aspect of the claimed invention, there is provided a stacked-winding stator for an axial flux electrical machine configured for use with a multi-phase power supply, the stacked-winding stator comprising: a first stator portion comprising a first plurality of conductive coils; and a second stator portion comprising a second plurality of conductive coils; wherein each conductive coil in the first plurality of conductive coils and the second plurality of conductive coils comprises at least one pair of active sections, wherein each active section extends in a generally radial direction substantially perpendicular to an axis of rotation of the electrical machine; wherein the first stator portion and the second stator portion are axially aligned and each comprise spaces between adjacent active sections for receiving flux guides, the spaces in the first stator portion being circumferentially aligned with the spaces in the second stator portion; and wherein each conductive coil in the first plurality of conductive coils has a corresponding conductive coil in the second plurality of conductive coils electrically connected to it to form a set of conductive coils.

Utilising two stator portions, rather than one large stator, reduces the amount of winding material needed, and hence the weight of the electric machine, without reducing the power output of the electric machine. This is because less material is needed to connect the active sections in the case of two stator portions compared to the case of one large stator, for a given (total) cross section of active section (i.e. comparing the active sections of both stator portions together with the case of the large stator).

The circumferentially aligned spaces in the first stator portion and the second stator portion may be configured to receive a common flux guide. The conductive coils of such a stator form a structure into which flux guides, such as lamination packs, can be placed. This reduces the number of components requiring assembly (compared to the case of both stator portions having their own sets of flux guides) and allows for the stator to be manufactured quickly, and also with a high degree of accuracy which improves the efficiency of the electrical machine. In particular this is achieved by providing a means to align the two stator portions in the form of the common flux guides. Additionally, the number of flux guides and, correspondingly, slots per pole per phase of the stator can be readily increased and readily scales with the radius of the electric machine. Increasing the number of slots per pole per phase can make the circumferential, spatial magnetic flux density within the stator and the two machine airgaps more sinusoidal, with lower harmonic distortion. For sinusoidally varying phase currents, the average torque that is produced by the electrical machine results more from the interaction of the fundamental magnetic field components and not from the harmonic components. This is advantageous because harmonic components in the circumferential spatial magnetic flux density result in larger eddy currents in the permanent magnets of the rotors, which causes higher losses and increased heating. Furthermore, any additional harmonic components in the winding magnetomotive force distribution can cause increased losses in the flux guides.

A flux guide may be positioned within each set of aligned spaces, such as a lamination pack, which may comprise grain-oriented electrical steel sheets surrounded by electrical insulation. Flux guides channel the flux axially between corresponding magnetic poles on opposing rotors. These flux guides may have high magnetic permeability in at least the axial direction and thus, for a specific arrangement of permanent magnets, increases the magnetic flux density in the stator.

Optionally, the active sections of each pair of active sections are pitched apart in a circumferential direction, and circumferentially adjacent conductive coils circumferentially overlap.

Optionally, the spaces include spaces of a first type, each space of the first type being a circumferential space between two adjacent active sections of two different conductive coils.

Optionally, each conductive coil comprises a plurality of pairs of active sections connected to each other in series, wherein adjacent pairs of active sections circumferentially overlap and wherein the spaces include spaces of a second type, each space of the second type being a circumferential space between two adjacent active sections of the same conductive coil but different pairs of active sections of the conductive coil. The circumferential space is, like the active sections defining the circumferential space, substantially radially extending and may be elongate in the radial direction. Each additional pair of active sections per coil per stator portion increases the number of slots per pole per phase by one, which can reduce losses and therefore improve efficiency. Advantageously, the number of active sections per coil can be scaled with the radius of machine.

The number of pairs of active sections may be an integer multiple of two. Using an integer multiple of two pairs of active sections readily allows each coil to be made from a plurality of identical conductive elements, which reduces manufacturing costs.

The plurality of pairs of active sections of each conductive coil may either be integrally formed or formed by connecting, in series, a plurality of separate elements which each comprise one pair of active sections. The connection may be made using a ferrule, by brazing or by welding, for example. Separate elements may be formed by winding, bonding and forming conductors which can be performed using known winding techniques that are relatively cheap to implement. Integrally forming elements may be expensive but may also allow for more complex coil topologies that cannot be achieved or are difficult to achieve by usual winding techniques. Furthermore, with integrally-formed elements, the number of constituent parts of the stator is reduced.

When in use, a current may flow in the same direction along adjacent active sections separated by one of the spaces of the second type. This avoids the current flowing in these adjacent active sections being counter-productive to torque production.

Optionally, in use, current flows in opposite radial directions along the active sections of each pair of active sections of each conductive coil. This may be achieved by having winding turn portions of the first and second generally radially extending active sections have proximal ends located at an inner radius and distal ends located at an outer radius. The proximal ends of the winding turn portions may be connected by inner loop sections and the distal ends may be connected by outer loop sections such that, in use, current flows in opposite radial directions along the pair of radially extending active sections.

The outer loop sections may be configured to form an outer part of the coil that is substantially parallel to the axis of rotation. An axially parallel part of the coil can be axially inserted into an aperture in a stator housing, which improves ease of stator manufacture. Further, the extended nature of the part of the coil provides a greater surface area for mechanical locking of the coils and cooling at the outside circumference of the stator. As noted previously, the use of two stator portions rather than a single large stator having the same total active section cross section reduces the amount of material required to form the outer loop sections, reducing the cost and weight of the electric machine.

Each outer loop section may have any shape but may preferably be substantially semi-circular or rectangular such that the outer part of the coil is a half-disk or rectangular surface. The surface may also be curved, for example involute-shaped. These surfaces create a large surface area yet also require a relatively limited length of conductor for a given axial extent of the coil, which reduces material costs.

The outer loop sections may be configured to form substantially involute parts of the coil. Involute parts, which maintain a substantially constant gap between adjacent conductive elements, provide for a radially-interlocking arrangement of circumferentially-distributed coils. There may be two substantially involute outer parts of the coil, connecting the outer part of the coil to the two active sections.

The inner loop sections may be configured to form an inner part of the coil that is substantially parallel to the axis of rotation. Being substantially parallel to the axis of rotation, the inner part takes up as little circumferential space as possible. This is significant as physical space is more limited at the inner radius of the stator, compared to the outer radius.

The inner loop sections may have any shape but may preferably be substantially semi-circular or rectangular such that the inner part is a half-disk or rectangular surface. The surface may also be curved, for example involute-shaped. These shapes require a relatively limited length of conductor to implement, which reduces material costs.

The inner loop sections may be configured to form a substantially involute part of the coil. Involute parts provide a radially-interlocking arrangement for circumferentially-distributed coils. There may be two substantially involute inner parts of the coil, connecting the inner part of the coil to the two active sections.

Optionally, the active sections of each pair of active sections are axially offset from each other. Axially offsetting the active sections facilitates stacking of the coils in the axial and circumferential direction, which provides for flexibility in the span (pitch) between each pair of active sections and also improves the structural rigidity of the complete winding owing to the interlocking nature of the coils.

Optionally, each active section comprises a plurality of axially and/or circumferentially stacked winding turning portions. Axially stacking winding turns, preferably insulated winding turns, mitigates skin and proximity effects in the active sections. This is because the cross-section of each winding turn is smaller and, given that the winding turns are series connected, the current is deterministically governed to flow over the full axial extent of each active section. This reduces heating, since the current is spread more evenly through the conductive cross-section.

Optionally, each active section is a single winding turn wide. Alternatively, each active section may be a plurality of winding turns wide. That is, each active section may comprise a plurality of circumferentially stacked winding turn portions. If each active section does comprise a plurality of circumferentially stacking winding turn portions, the number of circumferentially stacked winding turn portions is preferably less than the number of axially stacked winding turn portions, such that the major dimension of the cross-section of the coil that is perpendicular to the radially extending direction of the active section is parallel to the axis of rotation. For example, the active sections may be only two winding turn portions wide but comprise more than two winding turn portions in the axial direction. For example, the ratio of the number of axially stacked winding turn portions to the number of circumferentially stacked winding turn portions may be greater or equal to three, preferably greater or equal than five, more preferably greater or equal to seven. A coil that is more than one winding turn portion wide increases the overall length of conductor, which in turn increases the impedance of the coil. A higher impedance may allow the use of a controller with a lower switching rate, which may in some cases reduce costs.

Optionally, the respective active sections in each conductive coil for each set of conductive coils are aligned with one another in a circumferential direction.

Optionally, the respective active sections in each conductive coil for each set of conductive coils are offset from one another in a circumferential direction by an integer number of spaces.

Optionally, for an N phase power supply, each conductive coil in each set of conductive coils are connected to the same phase.

In this case, the stacked-winding stator may comprise a plurality of poles, each pole comprising an integer M multiple of N sets of conductive coils, with M sets of conductive coils for each phase.

Optionally, for each set of conductive coils, the conductive coil in the first plurality of conductive coils is connected in series to the conductive coil in the second plurality of conductive coils by a connector.

When the sets of conductive coils are connected by a connector in this manner, the stacked-winding stator may further comprise a first busbar arrangement and a second busbar arrangement, the first busbar arrangement comprising a first busbar for each phase and a star connection and the second busbar arrangement comprising a second busbar for each phase. For each of the N phases: each conductive coil from the first plurality of conductive coils in a first set of conductive coils in a first pole may be connected to the first busbar for the respective phase, and each conductive coil from the first plurality of conductive coils in a last set of conductive coils in a last pole may be connected to the star connection of the first busbar arrangement; and each conductive coil from the second plurality of conductive coils may be connected to the second busbar for the respective phase, such that a current path is formed from the first pole to the last pole via the sets of conductive coils and the second busbar for the respective phase.

Further, the first busbar arrangement may be disposed at a first axial end of the stacked-winding stator and the second busbar arrangement may be disposed at a second axial end of the stacked-winding stator. Positioning the busbar arrangements at the first and second ends (e.g. above and/or below the coils) allows for easy connection of the coils to the busbar arrangements, and also means that the connections may be accessible even after impregnation (potting) of the stator assembly with a resin or otherwise encapsulating the stator assembly (such as with a high-pressure plastic encapsulation or over-moulding process). This prevents a faulty connection from rendering the entire stator unusable.

For each phase, the second busbar of the second busbar arrangement may also comprise a plurality of second busbar portions configured to connect each set of conductive coils of the respective phase in series to form the current path from the first pole to the last pole.

The first busbar arrangement may be axially adjacent to the first stator portion in a first direction along an axis of the stacked-winding stator, and similarly the second busbar arrangement may be axially adjacent to the second stator portion in a second direction along the axis of the stacked-winding stator, the second direction being opposite to the first direction.

As an alternative to having the conductive coils in each set connected in series, they may be connected in parallel. That is, for each set of conductive coils, the conductive coil in the first plurality of conductive coils may be connected in parallel to the conductive coil in the second plurality of conductive coils by one or more connectors.

According to a second aspect of the invention, an electric machine is provided configured for use with a multi-phase power supply, the electric machine comprising: the stacked-winding stator of the first aspect of the invention (including any appropriate combination of the additional features described above); a first rotor portion disposed at a first axial end of the stacked-winding stator; and a second rotor portion disposed at a second axial end of the stacked-winding stator.

Optionally, a third rotor portion is disposed axially between the first stator portion and the second stator portion.

Optionally, each rotor portion comprises a number of magnetic poles equal to the number of poles of the stacked-winding stator. The angle by which each pair of active sections is pitched apart may be different than a pole pitch of the electrical machine defined by the permanent magnets. While the angle by which each pair of active sections is pitched apart may be the same as the pole pitch, using a different angle facilitates long-chording or short-chording of the winding. The angle by which each pair of active sections may be pitched apart is less than the pole pitch. Using a smaller angle allows short-chording, which can be used to further reduce harmonics in the stator field.

Each of the magnetic poles may comprises one or more permanent magnets, which may be arranged such that circumferentially adjacent magnetic poles have opposite polarities.

Corresponding magnetic poles on opposing rotors may have opposite poles facing one another. If so, the corresponding magnetic poles of opposing rotors may be circumferentially aligned. Alternatively, the corresponding magnetic poles of opposing rotors may be circumferentially offset. A circumferential offset between the rotors can reduce cogging torque.

If the corresponding magnetic poles of opposing rotors are circumferentially offset, they may be circumferentially offset by an angle equal to half the angle between circumferentially adjacent spaces.

The magnetic poles may occupy annular sectors about the axis of rotation of the rotor, or have approximately the shape of an annular sector. In some cases, particularly when the shape is approximately an annular sector, the edges of the magnetic poles may be skewed such that the edges of the magnetic poles are not radial. In this case, the edges of the magnetic poles may not align with the edges of the flux guides.

According to a third aspect of the invention, a conductive coil is provided for use in the first stator portion of the stacked-winding stator of the first aspect of the invention (including any appropriate combination of the additional features described above in relation to the first aspect), the conductive coil comprising at least one pair of active sections, a first terminal portion and a second terminal portion; wherein the first terminal portion is configured to extend axially in the first direction for connection to the first busbar arrangement; and wherein the second terminal portion is configured to extend axially in the second direction for connection to a connector, the second terminal portion having an extended portion configured to extend beyond the second stator portion in the second direction.

According to a fourth aspect of the invention, a conductive coil is provided for use in the second stator portion of the stacked-winding stator of the first aspect, when the coils in each set of conductive coils are connected in series and when the stacked-winding stator comprises first and second busbar arrangements, the conductive coil comprising at least one pair of active sections, a first terminal portion and a second terminal portion; wherein the first terminal portion is configured to extend axially in the second direction for connection to the second busbar arrangement; and wherein the second terminal portion is configured to extend axially in the second direction for connection to a connector.

The terminal portions may extend substantially parallel to the axis of rotation of the electric machine. Parallel extending connection portions allow for very simple connection of the coils to the connecting means.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE DRAWINGS

Embodiments of the invention will now be further described by way of example only and with reference to the accompanying figures in which:

FIG. 1 is a side view of an electric machine according to aspects of the invention;

FIG. 2 is a side view of an electric machine according to aspects of the invention;

FIG. 3A is a perspective view of the rotors and shaft of the axial flux machine of FIG. 1;

FIG. 3B is a plan view of one rotor of the axial flux machine of FIGS. 1A and 2A, more clearly showing the permanent magnets of the rotor;

FIG. 4 is a plan view of a stator according to aspects of the invention;

FIG. 5A shows plan and underneath views of a single conductive coil element having a single pair of radially extending active sections;

FIG. 5B shows two perspective views of the conductive coil element of FIG. 5A;

FIG. 5C shows two side views of the conductive coil element of FIGS. 5A and 5B;

FIG. 5D shows front-on and rear-on views of the conductive coil element of FIGS. 5A-5C;

FIG. 5E is a plan view of part of a stator that includes a plurality of the conductive elements of FIGS. 5A-5D circumferentially distributed around the stator, showing spaces resulting from their overlap;

FIG. 5F is a plan view showing the stator of FIG. 5E;

FIG. 5G is a plan view of a conductive element illustrating how the conductive element may be wound in a flat plane;

FIG. 5H is a side view of the conductive element illustrated in FIG. 5G;

FIG. 5I is a perspective view of the conductive element illustrated in FIGS. 5G and 5H;

FIG. 6A shows plan and underneath views of a conductive coil that includes two pairs of circumferentially overlapping radially extending active sections connected in series;

FIG. 6B shows two perspective views of the conductive coil of FIG. 6A;

FIG. 6C shows two side views of the conductive coil of FIGS. 6A and 6B;

FIG. 6D shows front-on and rear-on views of the conductive coil of FIGS. 6A-6C;

FIGS. 7A and 7B show a connection pattern for a stator according to aspects of the invention;

FIG. 7C shows a portion of a connection pattern for a stator according to aspects of the invention;

FIG. 7D shows an alternative connection pattern for a stator according to aspects of the invention;

FIGS. 8A, 8B and 8C show a coil according to aspects of the invention.

FIGS. 8D, 8E and 8F show a further coil according to aspects of the invention.

FIGS. 8G and 8H show an arrangement of the coil of FIGS. 8A-8C with the coil of

FIGS. 8D-8E.

FIG. 9 illustrates the material saving provided by aspects of the invention;

Like reference numbers are used for like elements throughout the description and figures.

### DETAILED DESCRIPTION

An embodiment of the invention will now be described with reference to an axial flux motor 100. While a motor 100 is described, it should be appreciated that the invention could equally be implemented in other types of axial flux electrical machines such as generators.

### Overview of an Axial Flux Machine

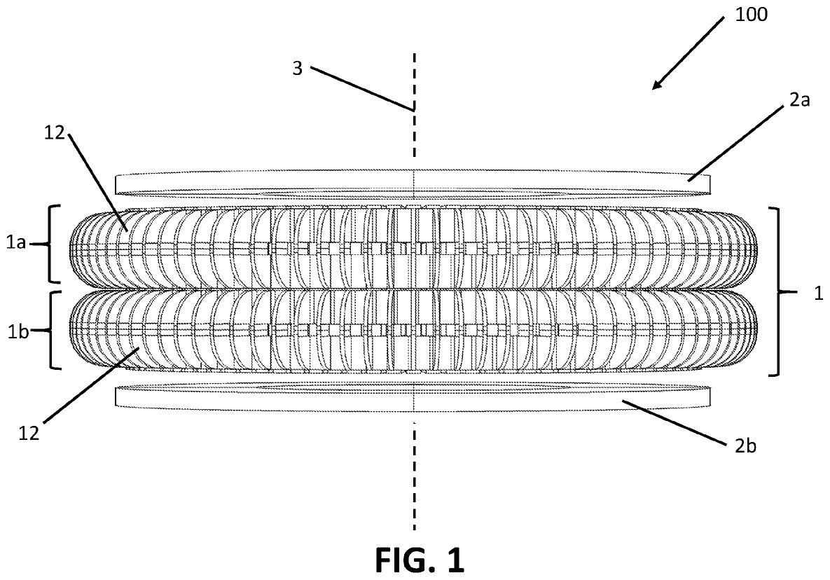

FIG. 1 illustrates the main components of the axial flux motor 100. The axial flux motor 100 includes a stator assembly 1 (also referred to as a stacked-winding stator 1 or just stator 1), two rotors 2a, 2b disposed on opposite sides of the stator assembly 1, and an axis of rotation 3. The stacked-winding stator 1 comprises a first stator portion 1a and a second stator portion 1b. The first stator portion 1a and the second stator portion 1b are axially aligned (that is, the axis of rotation 3 is also the common axis of both stator portions 1a, 1b).

The first stator portion 1a comprises a first plurality of conductive coils and the second stator portion 1b comprises a second plurality of conductive coils. As will be discussed in more detail below, each conductive coil 12 in both the first plurality of conductive coils and the second plurality of conductive coils comprises at least one pair of active sections. Each active section extends in a generally radial direction substantially perpendicular to the axis of rotation 3 of the electrical machine 100. Each stator portion 1a, 1b comprises spaces between adjacent active sections for receiving flux guides. The spaces in the first stator portion 1a are circumferentially aligned with the spaces in the second stator portion 1b.

In practice, a shaft will usually be present along the axis of rotation 3, and would typically include a drive end and non-drive end. The rotors 2a, 2b are typically fixedly mounted to the shaft. In use, the stator 1 of the axial flux motor 100 remains stationary and the rotors 2a, 2b and shaft rotate together relative to the stator 1. It should be appreciated that various components typically present in a motor 100, such as the shaft, rotor cover plates and means for connecting the stator to a source of power, have been omitted from FIG. 1 for clarity.

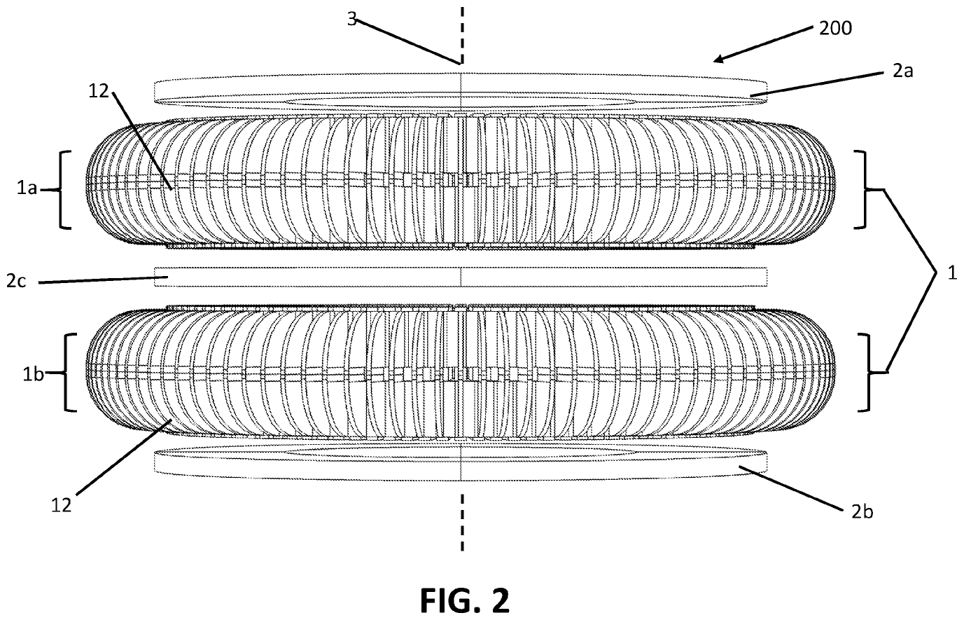

FIG. 2 illustrates a further implementation of an electric machine 200 wherein a third rotor 2c is disposed in between the first stator portion 1a and the second stator portion 1b. In the other regards, however, it can be seen that the electric machine 200 is generally similar to electric machine 100 illustrated in FIG. 1.

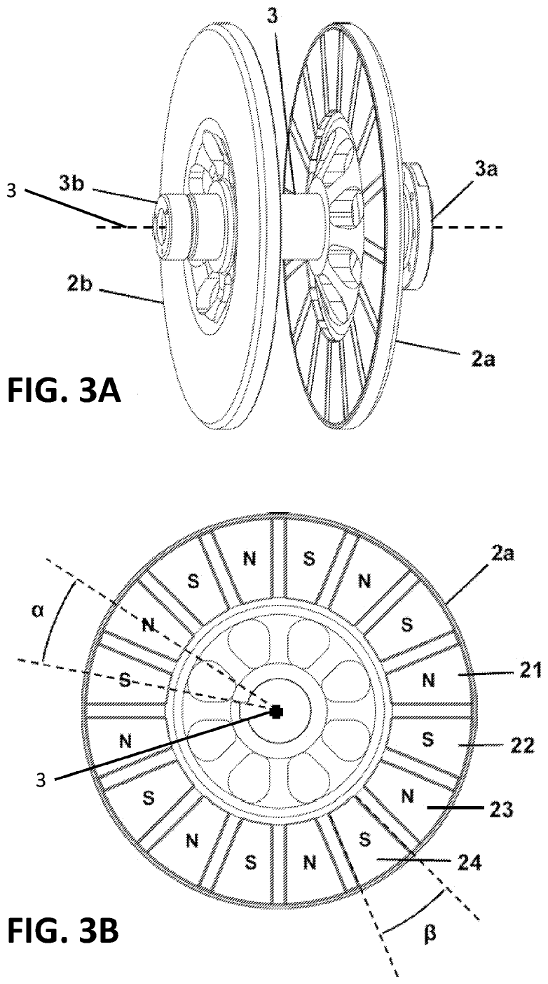

FIGS. 3A and FIG. 3B illustrate the rotors 2a, 2b and the shaft 3a, 3b disposed along the axis of rotation 3 of the motor 100 (without the stator assembly 1). As is particularly clear from FIG. 3B, each rotor 2a, 2b includes a plurality of circumferentially distributed permanent magnets 21, 22, 23, 24. The magnets 21, 22, 23, 24 are, for example, rare-earth magnets such as NdFeB magnets. Circumferentially adjacent magnets, such as permanent magnets 21 and 22, have opposite polarity. That is, each north pole 23 is circumferentially adjacent to two south poles 22, 24, and each south pole 22 is circumferentially adjacent to two north poles 21, 23.

Although it cannot be seen in FIGS. 3A and 3B, the rotors 2a, 2b are mounted such that opposing permanent magnets have opposite poles. That is, a north pole on rotor 2a faces a south pole on rotor 2b and vice versa. Consequently, the magnets of the two rotors 2a, 2b generate a magnetic field with axial lines of magnetic flux between the two rotors 2a, 2b.

As will be understood by those skilled in the art, the stator assemblies 1 described herein are yokeless but not ironless. A yoke is an additional structural element present in some stators for guiding lines of magnet flux between opposite poles of the rotor magnetic field. That is, the yoke completes the magnetic circuits within the stator. Since the axial flux machines 100 described herein utilize a pair of opposed rotors 2a, 2b whose opposed permanent magnets have opposite polarity, there is no need for a yoke to complete the magnetic circuits because the flux is unidirectional. Having a yokeless stator reduces the overall weight of the axial flux machine, which is greatly beneficial in many practical applications. In addition, it improves efficiency since there are no losses attributed to a varying flux density in a yoke region.

The circumferential (angular) separation a of the centres of two adjacent permanent magnets 21, 22 of the rotor 2a, 2b defines the pole pitch of the axial flux motor 100. It is noted that the average span of the permanent magnets 6 may be the same as or less than the pole pitch a of the motor 100. In FIGS. 3A-3B, adjacent magnets are separated by a non-magnetic spacer and so the average span 3 of the permanent magnets 21-24 is less than the pole pitch a of the motor 100. In an example, β is approximately 3/4 of α. The ratio of β to α can be chosen to reduce the circumferential, spatial harmonic distortion of the permanent magnet flux density in the stator 1. As will be appreciated, it is not essential to provide non-magnetic spacers to enable the span β of the permanent magnets 21-24 to be less than the pole pitch a of the motor 100. For example, the permanent magnets 21-24 can be affixed to the rotor using adhesive, or the like, in their required spaced apart positions.

The rotors 2a, 2b illustrated in FIGS. 3A-3B have sixteen circumferentially distributed permanent magnets 21-24 and therefore have sixteen poles. However, this is merely an example and in practice there may be greater or fewer than sixteen poles, partly depending on the intended application. For example, the poles typically exist in pairs (so there is typically an even number of poles) and the number of poles is to some extent limited by the radius of the rotors 2a, 2b, which will depend on the size of motor suitable for the intended application. The rotor 2a, 2b could, for example, have eight or thirty-two poles.

### Conductive Coils and Stator

The conductive components 10, including the conductive coils 12, of a stator assembly 1 will now be described. It should be appreciated that although specific examples are described, with specific numbers of stator poles 11, conductive coils 12 and current phases, this is not intended to limit the scope of the claims.

The core of the stator assembly 1, where the axial flux provided by the rotor magnets interacts with the radially flowing current flowing through the conductive components 10 to generate the torque that causes the rotors 2a, 2b to rotate, includes radially extending active sections of the conductive components 10 of the stator and flux guides, in this example in the form of lamination packs. The flux guides, in the form of lamination packs, which may comprise grain-oriented electrical steel sheets surrounded by electrical insulation, are positioned in spaces between the radially extending active sections of the conductive components 10 of the core. The flux guides, in the form of lamination packs, act to channel the magnetic flux produced by the permanent magnets (e.g. 21-24) between the current carrying conductors.

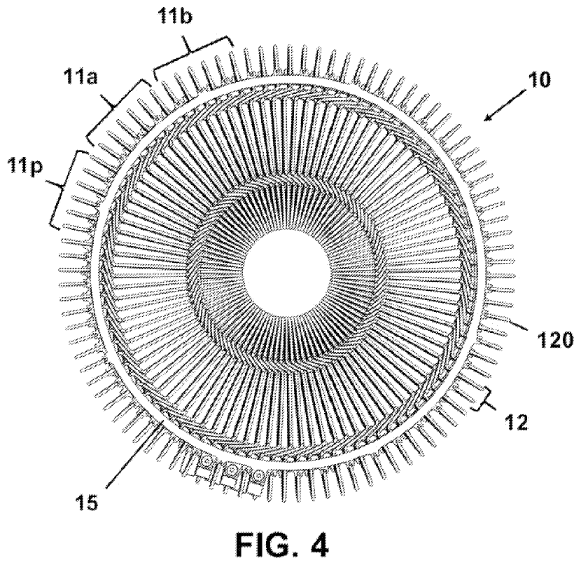

Turning to FIG. 4, the conductive components 10 that form a stator portion 1a, 1b (which from now on will be simply referred to as the “stator portion 10”) are shown without the stator housing or the flux guides, in the form of lamination packs. As can be appreciated from the top-down view of FIG. 4, the stator portion 10 has distributed windings and comprises a plurality (in this case sixteen) of circumferentially distributed stator poles 11a, 11b, . . . , 11p, each of which comprises a plurality of conductive coils 12. Each conductive coil 12 is connected to one phase of a multi-phase power supply via connection means 15, which in this example take the form of busbars. Examples of specific connection arrangements will be discussed subsequently in this application. In this specific example, the stator portion 10 is configured for use with a three-phase power supply so there are three conductive coils 12 per pole 11a-11p of the stator.

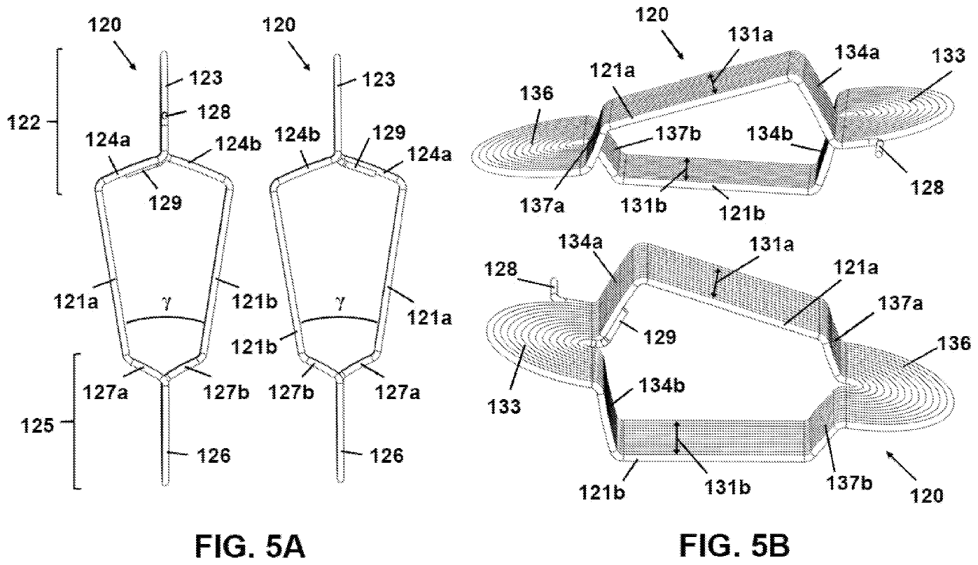

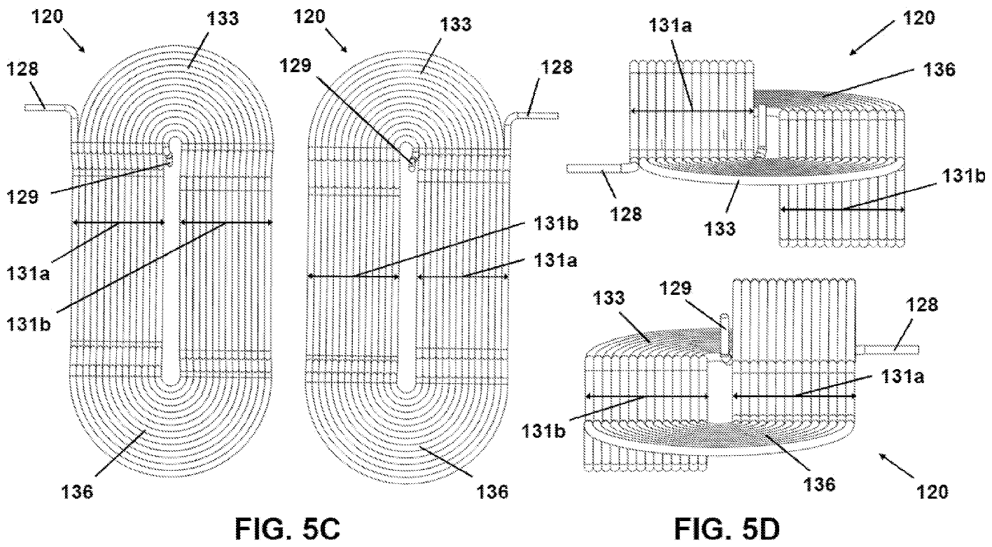

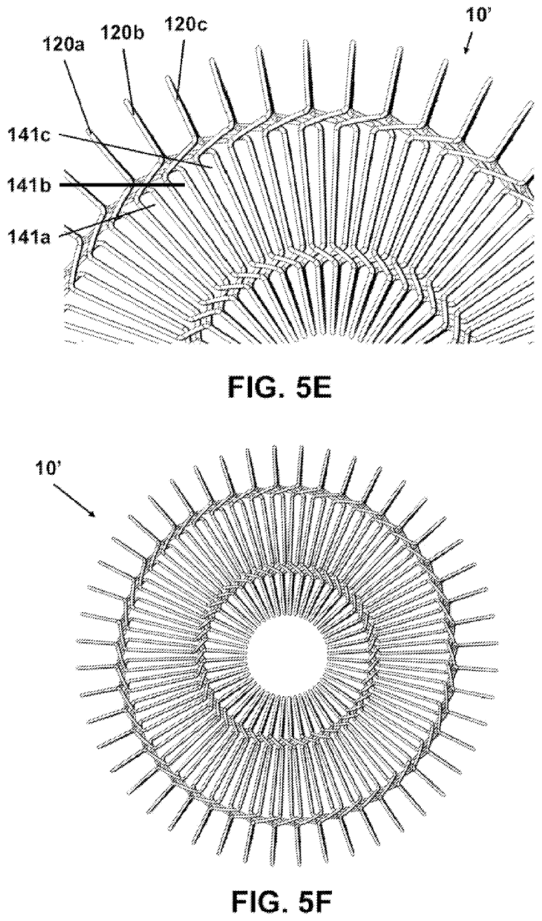

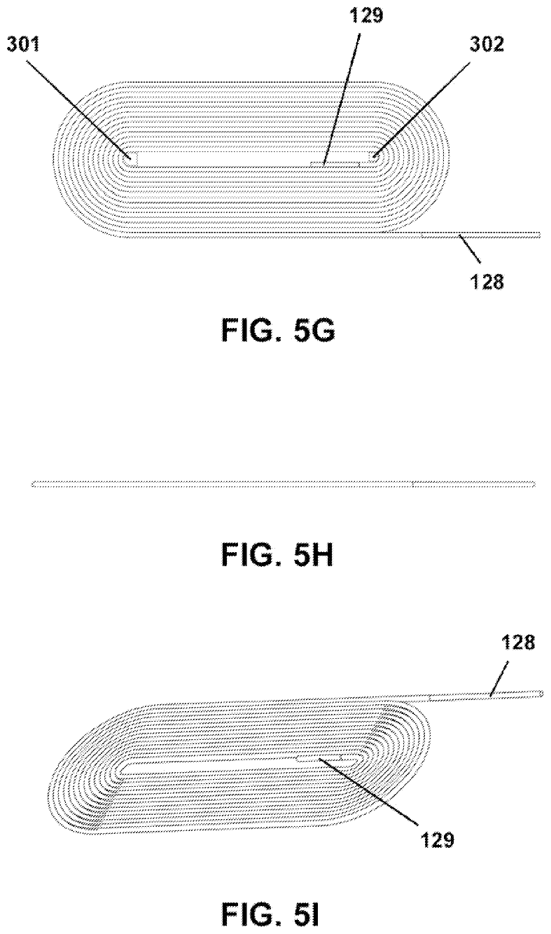

It will be appreciated that with sixteen poles 11a-11p and three conductive coils 12 per pole, the stator portion 10 of FIG. 4 has a total of 48 circumferentially distributed conductive coils 12. However, it can be seen from the top-down view of FIG. 4 that this stator portion 10 actually has 96 radially extending active sections. Further, whilst unseen in the plan view of FIG. 4, but as will be apparent from subsequent Figures, there are two axially offset layers of radially extending active sections, giving a total of 192 radially extending active sections. The reasons for this will become apparent from the description of FIGS. 5-9. In summary, each conductive coil 12 includes one or more conductive elements 120, each of which includes a pair of axially offset radially extending active sections. Each conductive coil 12 of the stator portion 10 of FIG. 4 includes two such conductive elements 120, and since each conductive element 120 includes a pair of axially offset radially extending sections, the total of 192 radially extending active sections is accounted for.

The conductive components of stator portion 10 may be made of any combination of one or more conductive materials. However, the conductive components 10 are preferably made from copper.

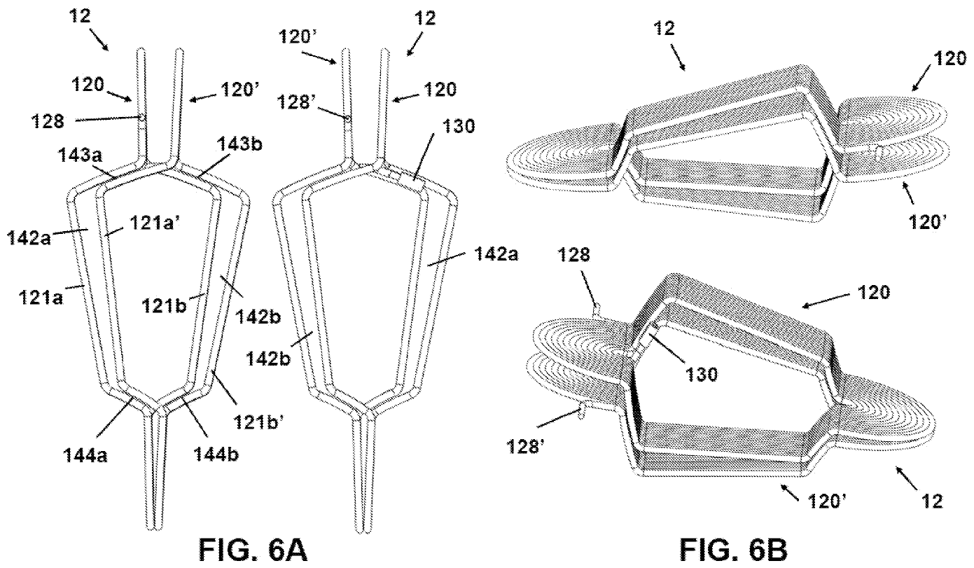

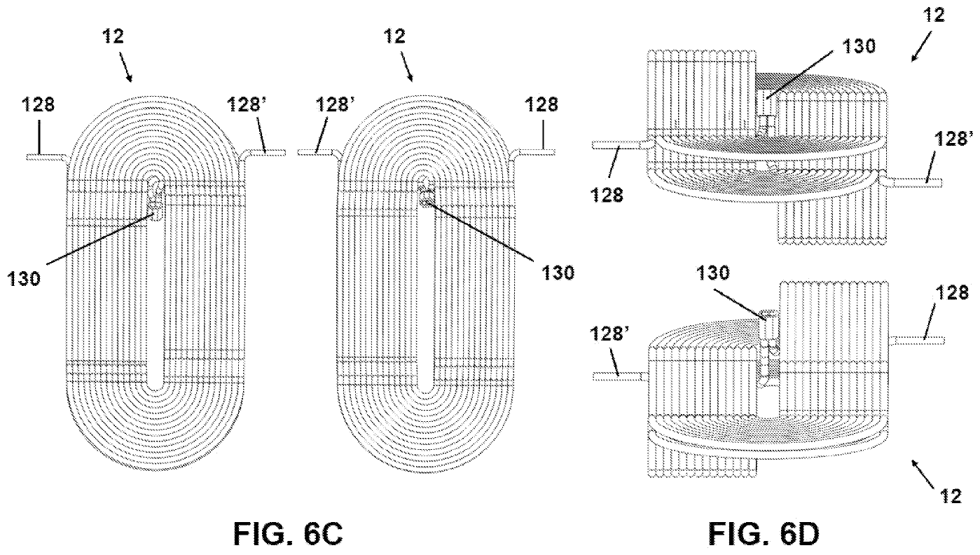

FIGS. 5A-5D are various views of a single conductive element 120. As noted above and as will be explained in more detail below, each conductive coil 12 is made up of one or more conductive elements 120. It will be appreciated that in the case of one conductive element 120 per conductive coil 12, a conductive coil 12 and a conductive element 120 are equivalent. FIGS. 6A-6D illustrate a conductive coil 12 which is made up of two conductive elements 120 and 120′, and will be described below.

Returning to FIGS. 5A-5D, as is best appreciated from the top-down views of FIG. 5A in which the axis of rotation is perpendicular to the plane of the page, a conductive element 120 includes a pair of circumferentially pitched apart, radially extending active conducting sections 121a, 121b. These radially extending active sections 121a, 121b are referred to as “active” sections because, when the conductive coils 12 are positioned in the stator, they are disposed within the stator core and so interact with the magnetic field provided by the magnets of the rotors 2a, 2b. It will be appreciated that since the active sections extend in a generally radial direction, which is approximately perpendicular to the axial flux in the core, the flux linkage is at least close to maximized.

The angle γ by which the two active sections 121a, 121b are pitched apart will be referred to as the coil span. The coil span can be the same as or different (less or more) than the pole pitch a (defined by the angle between the centres of the permanent magnets of the rotor). Preferably the coil span γ is less than the pole pitch α. For example, γ may be approximately 5/6 of α. By making γ less than α, short-chording of the winding can be implemented, which reduces the spatial harmonic content of the winding magnetomotive force (mmf).

Turning to FIGS. 5E and 5F, these show a sixteen-pole, three-phase stator portion 10′ which is similar to the stator portion 10 of FIG. 4, but differs in that each coil 12 of stator portion 10′ has only one conductive element 120 (one pair of active sections 121a, 121b). That is, in FIGS. 5E and 5F, a coil 12 and a conductive element 120 are equivalent. Like stator portion 10, conductive coils 120a, 120b, 120c of stator portion 10′ are circumferentially distributed around the stator and circumferentially adjacent coils circumferentially overlap.

As is particularly clear from FIG. 5E, the circumferential overlap of the coils 120a, 120b, 120c defines circumferential spaces between active sections of the coils. These circumferential spaces, which are elongated in the radial direction, can receive flux guides. Spaces such as the labelled spaces 141a, 141b, 141c will be referred to as spaces of the first type. As can be seen, spaces of the first type 141a, 141b, 141c are defined between active sections of different coils. For example, space 141b is between one of the two active sections of coil 120a and one of two active sections of coil 120c. However, it is to be appreciated that the two coils that define a particular space of the first type 141a, 141b, 141c can depend on various factors, including the number of phases per stator pole, the number of poles and the selected coil span γ.

Now returning to FIGS. 5A-5D, as can be seen from FIGS. 5B and 5D, the two active sections 121a, 121b are axially offset from each other. This facilitates stacking of the conductive coils 12 in the circumferential direction, and also facilitates of the circumferential stacking of conductive elements 120 where there are multiple conductive elements 120 per conductive coil 12. This allows for more stator poles and more slots per pole per phase, both of which can provide for greater efficiency. Furthermore, the winding may be readily short chorded.

As can be seen in each of FIGS. 5B, 5C and 5D, each conductive element 120 is formed from a continuous length of wound conductor. The outermost winding of the length of conductor terminates at a first terminal portion 128, which will be referred to as the outer tail 128. The outer tail 128 extends substantially parallel to the axial direction. As will be described in more detail below, this facilitates convenient connection of the coils 12 to the multi-phase power supply. The innermost winding turn portion terminates at a second terminal portion 129, which will be referred to as the inner tail 129.

As can also be seen in each of FIGS. 5B, 5C and 5D, the length of conductor that forms the conductive element 120 is wound such that there are a plurality of winding turn portions 131a, 131b stacked parallel to the axis of rotation of the electrical machine. The resulting cross-section of the conductive element 120 that is perpendicular to the radial direction of each active section 121a, 121b is elongate with a major dimension parallel to the axis of rotation. In the example of FIGS. 5A-5D, there are fourteen axially stacked winding turn portions 131a, 131b, though this not intended to limit the invention as other numbers are equally possible.

FIGS. 5G, 5H and 5I illustrate how the conductive element 120 may be formed by winding a length of conductor. As illustrated in FIG. 5G, the conductor is wound around a pair of support elements 301, 302 (which protrude perpendicularly out of the plane of page) in a single plane so as to form a flat, planar winding with a number (in this case fourteen) of turns or layers. That the winding is flat is best appreciated from FIGS. 5H and 5I. The innermost winding terminates at the inner tail 129 and the outermost winding terminates at the outer tail 128.

Having formed the flat winding shown in FIGS. 5G-5I, the three-dimensional shape of the conductive element 120 is formed by bending or deforming the flat winding into the shape shown in FIGS. 5A-5D. The bending can be performed using a bending tool, as is known in the art. For example, a bending tool with axially offset inner male profile blocks may push against outer female forms to bend the flat winding so that the active sections are axially offset from each other. The outer tail 128 and inner tail 129 may be separately bent as desired.

To make the bending process easier, the flat winding may first be imparted with additional strength so that the winding maintains its shape during the bending. In one example, the conductor has a heat-or solvent-activated outer bond layer so that after winding, the turns/layers can be bonded together to maintain the shape.

It should be appreciated, particularly from FIGS. 5G-5I, that the conductive element 120 can be wound in a variety of different ways, and the particular winding that is illustrated is not intended to limit the invention. Some alternatives include:
While the winding in FIG. 5G has been wound around the support elements 301, 302 in an anti-clockwise sense, the length of conductor could equally be wound in the clockwise sense.
While the outermost turn of the winding terminates such that that outer tail 128 leads into an active section 121a, 121b of the conductive element 120, this need not be the case. The outer turn could terminate at any point of the turn, for example so that the outer tail 128 leads into a loop section of the turn rather than an active section.
While fourteen axially stacked winding turns are illustrated in FIG. 5, there could be more than or fewer than fourteen turns.
While the winding is one turn/layer thick (see FIG. 5H in particular), it could be more than one turn/layer thick. In this case, each conductive element 120 will comprise a plurality of circumferentially stacked winding turn portions. While any number of circumferentially stacked winding turn portions is possible, the number will preferably be less than the number of winding turn portions in the axial direction, such that the cross-section of the conductive element 120 that is perpendicular to the radial direction of each active section 121a, 121b still has a major dimension that is parallel to the axis of rotation. For example, the ratio of the number of axially stacked turns to the number of circumferentially stacked turns may be greater than three, and may preferably be greater than five.

As will be appreciated from the above, in use, current will flow along the two active sections 121a, 121b of the conductive element 120 in opposite directions (that is, inward and outward parallel to the radially extending direction). The reversal of the current direction is provided by outer loop sections 122 of the winding turn portions 131a, 131b and by inner loop sections 125 of the winding turn portions 131a, 131b. Each of the outer loop sections 122 includes a first portion 123 and a pair of second portions 124a, 124b (one for each of the pair of active sections 121a, 121b) which connect the active sections 121a, 121b to the first portion 123. Similarly, each of the inner loop sections 125 includes a first portion 126 and a pair of second portions 127a, 127b (one for each of the pair of active sections 121a, 121b) which connect the active sections 121a, 121b to the first portion 126.

As can be seen from FIGS. 5B, 5C and 5D, the outer first portions 123 together form an outer part 133 of the coil element 120 with a surface that is substantially parallel to the axis of rotation. In the specific example of FIGS. 5A-5D, the outer first portions 123 are substantially semi-circular and so the outer part 133 is a substantially flat half-disk 133, but other shapes are possible. For example, each of the outer first portions 123 may have a shape corresponding to three sides of a rectangle, such that they together form an outer part 133 which has a flat rectangular surface. As another example, the outer part 133 of the conductive element 120 formed by the outer first portions 123 need not be flat or planar.

The surface 133 formed by the outer first portions 123 can be used to facilitate cooling due to its relatively large surface area. Further, since the outer part 133 of the coil 120 is substantially parallel to the axis of rotation, a stator housing may be provided with axially extending apertures which axially receive the outer part 133 of the coil element 120′, 120″ to provide mechanical locking and improved cooling.

The inner first portions 126 together form an inner part 136 of the coil element 120. The inner part 136 illustrated in FIGS. 5B-5D is substantially the same as the outer part 133 described above, and like the outer part 133 described above may be parallel to the axis of rotation and may be of various shapes and profiles. However, the inner part 136 will generally play less of a role in cooling and stacking of the coils 12, and so the inner portions 126 may be configured so as to reduce the overall quantity of conductor per conductive element 120 to reduce costs.

With regards to the outer second portions 124a, 124b and the inner second portions 127a, 127b, while they appear substantially straight in FIGS. 5A-5D, they are in fact slightly curved. Specifically, the shape of each of the outer first portions 124a, 124b is a section of a first involute, and so the first portions 124a, 124b together form outer substantially involute parts 134a, 134b of the coil element 120. Similarly, the shape of each of the inner second portions 127a, 127b is a section of a second involute, and so the first portions 127a, 127b together form inner substantially involute parts 137a, 137b of the coil element 120. The significance of the involutes will be described with reference to FIGS. 6A-6D.

While it has been described above that the conductive element 120 is formed by winding a length of conductor, this is not essential. The conductive element 120 could be manufactured in other ways, including by being formed integrally.

Further, while the illustrated elements 120 are wound from a length of conductor and comprise a stack of winding turn portions 131a, 131b, this is preferred but not essential. For example, rather than axially extending stack of winding turn portions 131a, 131b, each conductive element 120 could be formed by a single axially extending conductive strip. In some cases a single axially extending conductive strip may be preferable to a plurality of axially stacked winding turn portions 131a, 131b but, as will be described below, the use of stacked winding turn portions 131a, 131b advantageously helps mitigate the skin and proximity effects which can otherwise lead to increased losses.

As noted above, each conductive coil 12 may include only one conductive element 120. However, for reasons which will be explained in more detail below, each conductive element preferably includes two or more circumferentially overlapping conductive elements.

An example of a conductive coil that includes two circumferentially overlapping conductive elements 120, 120′ will now be described with reference to FIGS. 6A-6D.

FIG. 6A shows above and below views of a conductive coil 12 which includes two conductive elements 120, 120′. The features of each of the two conductive elements 120, 120′ are the same as those of the single conductive element 120 described above with reference to FIGS. 5A-5D, and so their features will not be described again.

To form the conductive coil 12, two identical conductive elements 120, 120′ are electrically connected together in series at their inner tails 129, 129′. In the examples illustrated herein, the inner tails 129, 129′ are connected using a ferrule 130. However, there are other ways of connecting the inner tails 129, 129′, such as brazing or welding. To connect the two elements 120, 120′, one of the two conductive elements 120, 120′ is rotated 180° about the axis running vertically in the plane of the page in FIG. 6A so that the outer tails 128, 128′ of the two conductive elements 120, 120′ are in opposite directions and the inner tails 129, 129′ are adjacent and therefore readily connected by a ferrule 130. Alternatively, the conductive coil 12 comprising two conductive elements could be integrally formed as a single piece.

The resulting conductive coil 12 has two pairs of circumferentially overlapping, pitched apart pairs of active sections 121a, 121b; 121a′, 121b′. Notably, the overlap of the two pairs of active sections defines two spaces 142a, 142b. The first space 142a is defined between one (a first) active section 121a of a first of the conductive elements 120 of the coil 12 and between one (a first) active section 121a′ of the second of the conductive elements 120′ of the coil 12. The second space 142b is defined between the other (the second) active section 121b of the first conductive element 120 of the coil 12 and between the other (the second) active section 121b′ of the second conductive element 120′ of the coil 12. That is, the two spaces 142a, 142b are circumferential spaces between adjacent active sections 121a, 121a′; 121b, 121b′ of two different pairs of active sections 121a, 121b; 121a′, 121b′ of the same coil 12. Spaces of this type will be referred to as spaces of the second type. Like the spaces of the first type, spaces of the second type 142a, 142b provide spaces for flux guides, such as lamination packs. This makes it easier to construct the stator assembly 1, and also increases the number of slots per pole per phase of the stator assembly 1, which can increase the motor's efficiency.

Having now described spaces 141a-c of the first type (that is, spaces defined between active sections of different coils) and spaces 142a-b of the second type (that is, spaces defined between active sections of the same coil but different pairs), it is noted that when a plurality of coils 12 which define spaces of the second type are provided in a stator portion 10 so as to define spaces of the first type, the spaces of the first and second types may coincide. Whether spaces of the first and second type coincide may depend on a number of factors, including the selected coil span γ, the number of stator poles and the number of phases.

Returning to FIGS. 6A-6D, it can also be seen from FIGS. 6A and 6B that there is a gap 143a between the second portions 124a, 124a′ of the outer loop sections 122, 122′ which form one pair of outer involute parts 134a, 134a′ of the two conductive elements 120, 120′. Likewise, there is a gap 143b between the second portions 124b, 124b′ of the outer loop sections 122, 122′ which form the other pair of outer involute parts 134b, 134b′. There is also a gap 144a between the second portions 127a, 127a′ of the inner loop sections 125, 125′ which form one pair of inner involute parts 137a, 137a′. Finally, there is also a gap 144b between the second portions 127b, 127b′ of the inner loop sections 125, 125′ which form the other pair of outer involute parts 137b, 137b′. Due to the geometric properties of involutes, the width of these gaps 143a, 143b, 144a, 144b remains substantially constant along the length of the involute sections of the conductive elements 120, 120′. This advantageously reduces the resulting diameter of the motor for a given rating and losses in the coils.

While a conductive coil 12 with two conductive elements 120, 120′ has been described, it should be appreciated that a conductive coil 12 could have any integer number of conductive elements 120, including more than two. Increasing the number of conductive elements per conductive coil 12 will increase the number of spaces of the second type defined by the circumferentially adjacent active sections of the conductive elements 120, which in turn increases the number of slots per pole per phase in the stator 1. This can lead to the generation of a stator magnetic field with a more accurately sinusoidal magnetic flux density, with less significant harmonic distortion. This advantageously reduces the development of eddy currents in the permanent magnets of the rotors 2a, 2b, which in turn reduces heating losses and therefore provides a higher motor efficiency. However, it will be appreciated that the number of conductive elements 120 per conductive coil 12 will generally be limited by size constraints. For example, for a given cross-section of conductor (that is, the cross-section of the wire from which the windings are wound) and a given radius of the stator, the number of conductors which can be circumferentially fit into a single coil span γ is limited.

If a coil 12 is to have more than two conductive elements, there may be several further considerations. For example:
If the coils are to be formed by connecting multiple conductive elements 120 (by ferrules 130, for example), it may be preferable to provide several types of conductive elements to facilitate simpler connection of adjacent conductive elements. For instance, the conductive elements 120 described above may be used for the two circumferentially outer conductive elements, since their outer tails 128 will be connected to the power-supply. However, the one or more inner conductive elements that are between the outer conductive elements will be connected to conductive elements at both their inner tails 129 and outer tails 128, so a second type of conductive element with outer tails 128 adapted in a similar fashion to the inner tails 129 may be provided for ease of connection. Alternatively, each coil 12 may be formed as an integral unit, rather than by the connection of three or more separate conductive elements.
Integer multiples of two conductive elements 120 per coil 12 may be preferable to an odd number of conductive elements 120 per coil 12. If an integer multiple of two elements 120 are used, the outer tails 128 of the two circumferentially outermost elements 120 will be directed in opposite parallel directions, as in FIG. 6A-6D. While this is not essential, it can provide for a more straightforward connection of the coils 12 in some instances, as discussed further below.

### Connecting the Coils to a Multi-Phase Power Supply

Ways of connecting a plurality of circumferentially distributed conductive coils 12 to a multi-phase power supply will now be described. It should be appreciated that in practice there are many different ways which this could be accomplished, and many different ways will occur to one skilled in the art. The invention is therefore not limited to any particular connection arrangement. However, the described ways of connecting the conductive coils 12, which utilize connection means which are provided axially above/below a plane that is perpendicular to the axis of rotation and axially above/below the conductive coils, provides a particularly neat and well-organized set of connections. Further, the connections are easy to make, which reduces the likelihood of a poor connection, and the stator may be resin impregnated or otherwise encapsulated (such as using a high-pressure plastic encapsulation or over-moulding process) without impregnating or encapsulating the connection means, which allows connections to be checked and fixed even after impregnation of the stator assembly.

First referring to FIG. 4, there is a first connection means 15 that is provided axially above the stator portion 10 in a plane that is perpendicular to the axis of rotation of the motor 100 and that is axially above the conductive coils 12. When two such stator portions 10 are used in the manner of the present invention, a second connection means will be similarly located on the opposite side of the other stator portion. That is, a connection means will be disposed either end axially of the combination of the first and second stator portions.

The first connection means 15 and the second connection means can be implemented in a variety of manners. In one implementation the first and second connection means comprise a first and second busbar arrangement respectively. The first busbar arrangement comprises a first busbar for each phase that the electric machine is configured to be powered by, and the second busbar arrangement similarly comprises the same number of second busbars, again one for each phase. For example, for a three-phase device, each busbar arrangement will comprise three busbars, one for each phase. More generally, for an N phase device, each busbar arrangement will comprise N busbars, one for each phase. In addition, the first busbar arrangement also comprises a star connection which can be connected to neutral.

In one specific example, the connection means are busbars that are continuous and annular around the axis of the stator, though this is merely one way of implementing them.

For example, the connection means may not be continuous or annular, and may instead take the form of a series of two or more circumferentially distributed busbar sections. This may be particularly the case when the stacked-winding stator comprises a number of poles that are connected in series. In this case, the busbars may comprise a plurality of separate sections, with each section connecting adjacent poles of the stator.

Each busbar of the busbar arrangement is formed of an electrically conductive material, such as copper, and is insulated from the other busbars. Many other kinds of connection means will occur to those skilled in the art.

The conductive coils in each stator portion are arranged in corresponding sets, with each set comprising a coil from each stator portion. In other words, each conductive coil in the first plurality of conductive coils has a corresponding conductive coil in the second plurality of conductive coils. The coils in each set of coils are connected together by one or more connectors, also referred to as jumpers. These sets of coils are arranged in a number of poles and connected to the desired phases of the electric machine via the busbar arrangements and the connectors.

For each phase, a first pole can be defined as comprising a set of conductive coils (a first set of coils)—one coil from the first plurality of conductive coils and one from the second plurality of conductive coils. The coil from the first plurality of coils in this first pole is connected to the first busbar for the respective phase.

Similarly, for each phase a last pole can be defined comprising a different set of coils from the two stator portions (a last set of coils). It should be noted that the last pole may be adjacent to the first pole or it may not be—the terms “first pole” and “last pole” do not imply a physical positional relationship. The coil from the first plurality of conductive coils in this last set of coils is connected to the star connection of the first busbar arrangement. It is noted that as the star connection is a neutral connection, the relevant coils for each phase can all be connected to the same star connection.

Regarding the second busbar arrangement, each conductive coil from the second plurality of conductive coils is connected to the second busbar for the respective phase such that a current path is formed from the first pole to the last pole via the sets of conductive coils and the second busbar for the respective phase.

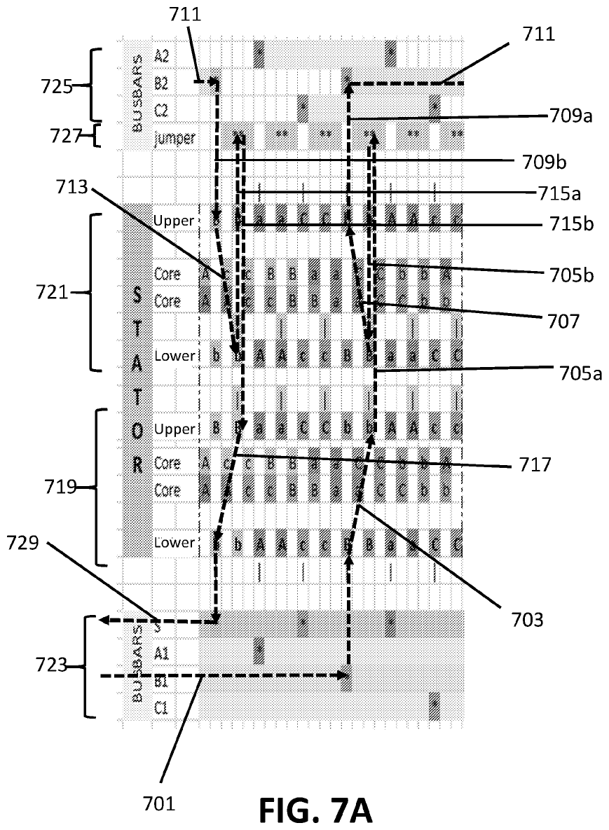

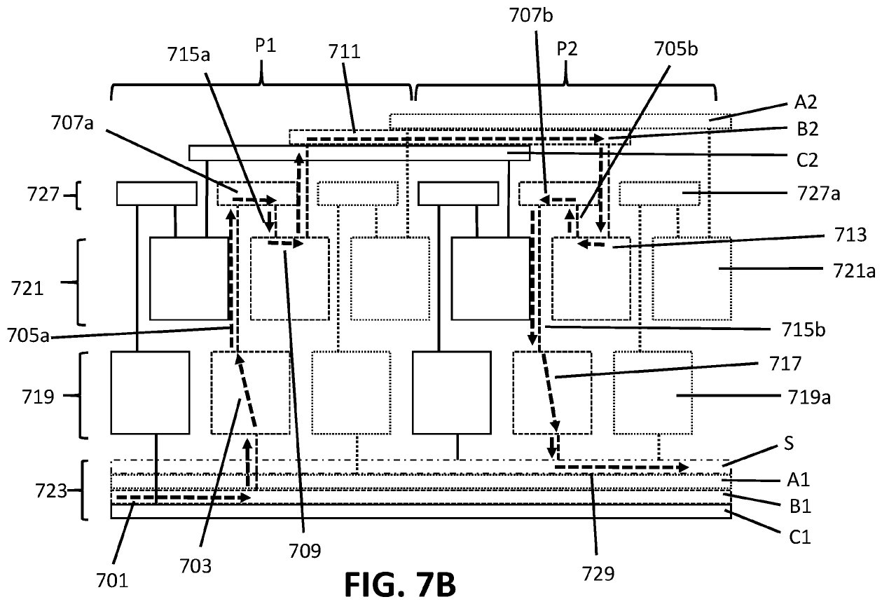

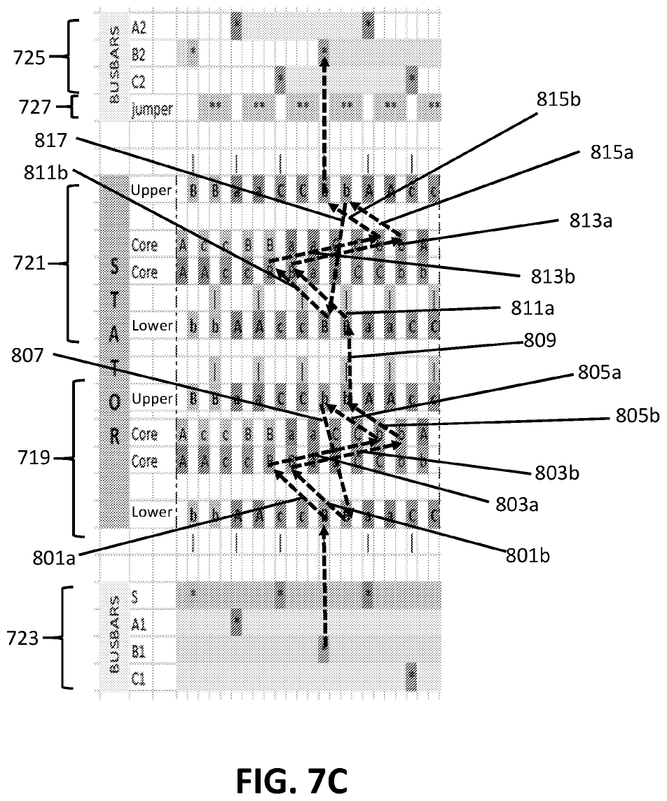

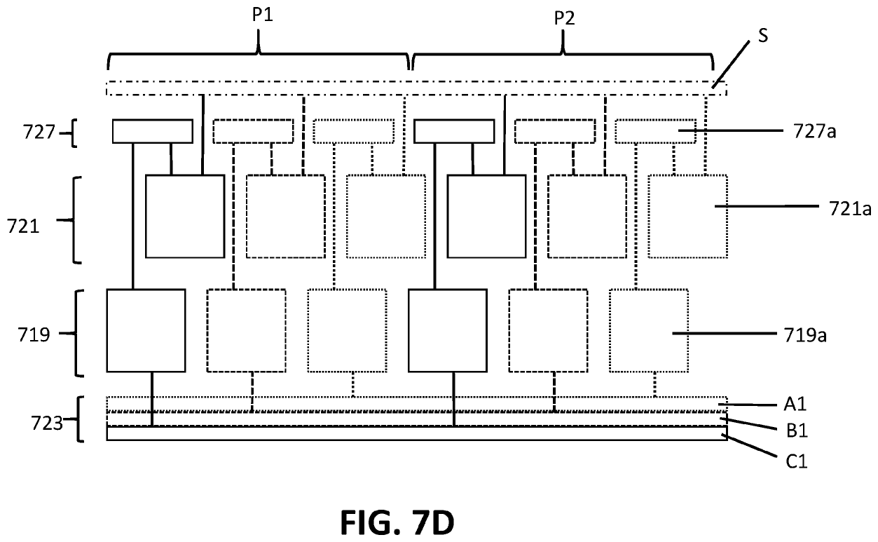

Such a connection arrangement is illustrated in FIGS. 7A and 7B. These Figures both show stacked-winding stators wherein adjacent poles are connected in series.

FIGS. 7A and 7B each show a representation of a stacked-winding stator comprising first 719 and second stator portions 721, along with first 723 and second busbar arrangements 725 and a number of connectors 727, also called jumpers 727 in FIG. 7A. The first busbar arrangement 723 comprises three first busbars A1, B1, C1, one for each phase, and a star connection S, and is disposed at a first axial end of the stacked-winding stator. The second busbar arrangement 725 comprises three second busbars A2, B2, C2, one for each phase, and is disposed at a second end of the stacked-winding stator. The plurality of connectors 727, or jumpers 727, provide a connection between the coils of the two stator portions 719, 721, and are disposed between the coils of the stacked-winding stator and the second busbar arrangement 725.

As is apparent from the number of first and second busbars, the stacked-winding stator of FIGS. 7A and 7B are both configured for use with a three phase supply. In FIG. 7A, the three phases are represented by the letters A, B and C, whilst in FIG. 7B the three phases are represented by the letters A, B and C, as well as by the different line styles (solid, dashed, and dotted). Each stator portion comprises 12 conductive elements. In FIG. 7A, each conductive element is represented by a “Lower” section, two “Core” sections and an “Upper” section. These terms, used for ease of description rather than implying any absolute orientation, are used with respect to the longitudinal axis of the stacked-winding stator (which would be coaxial with the axis of rotation when assembled into an electric machine). The second busbar 725 is at the “Upper” end of the stator, whilst the first busbar 723 is at the “Lower” end of the stator. The “Upper” and “Lower” portions of the conductive elements correspond to the terminal portion of each conductive element within a coil closest to the respective ends of the stator, whilst the “Core” portions correspond to the active sections 121a and 121b, as illustrated in FIG. 5A-5D.

It will be appreciated that FIGS. 7A and 7B are both merely two different schematic representations to aid in understanding the electrical connections in a stacked-winding stator according to this disclosure, and hence the positions of parts of the stacked-winding stator and the coils in FIG. 7A and 7B do not correspond precisely to the physical position of the parts.

The conductive elements of each stator portion are divided into two groups of six conductive elements (P1 and P2 in FIG. 7B), with each group corresponding to a pole of the stacked-winding stator. Hence, the stacked-winding stators of FIGS. 7A and 7B are two pole devices, though it will be appreciated that the connection methodology described below can be applied to stators with any number of poles.

Within each group (i.e., for each pole), the conductive elements are arranged into a number of coils. Each coil comprises two adjacent conductive elements connected in series and corresponds to a single phase. The boxes 719a and 721a in FIG. 7B each correspond to one coil, and thus represent two adjacent conductive elements connected in series.

An exemplary current path has been illustrated in FIGS. 7A and 7B via the arrows, following the current of phase B.

Initially, the current travels along the first busbar for phase B, busbar B1. This is illustrated by arrow 701. From busbar B1, the current then passes through the coil in the first pole of the first stator portion 719, as shown by arrow 703. That is, within the first stator portion, the current passes through the coil corresponding to phase B in the group corresponding to the first pole. Because the conductive elements within each coil are connected in series, the current would in fact pass through the first conductive element in the coil first and then the second conductive element in the coil. However, in FIG. 7A, for clarity, arrow 703 is shown as extending from the lower portion of the first conductive element of the coil to the upper portion of the second conductive element of the coil, whilst in FIG. 7B arrow 703 extends from one side of the box to the other, both cases representing the current flowing through both conductive elements one after the other.

From the upper portion of the second B coil in the first stator portion 719, the current progresses to the jumpers 727, in the direction of arrow 705a. As illustrated in FIG. 7A, the connection to the first busbar B1 is at the lower portion of the coil (e.g. in the form of an outer tail 128 as illustrated in FIGS. 5A-5D), whereas the connection to the jumpers 727 is at the upper portion. From the jumpers 727, the current path continues into the second stator portion 721 along arrow 705b to pass through the corresponding coil in the second stator portion 721 (illustrated by arrow 707) and then into the second busbar B2 (illustrated by arrow 709a). This concludes the portion of the current path through the first pole of the stacked-winding stator (P1 in FIG. 7B).

The current path then passes along the second busbar B2 (illustrated by arrow 711) and into the coil of the second pole (P2 in FIG. 7B) in the second stator portion 721, passing along arrow 713. From these coils, the current then moves to back to the jumpers 727 in the direction of arrow 715a, and then through the coil of the second pole in the first stator portion 719 (illustrated by arrows 715b and 717). After passing through the coil of the first stator portion 719 of the second pole (arrow 717), the connection then terminates on the star connection S, indicated by arrow 729. This concludes the portion of the current path through the second (and in this case last) pole (P2 in FIG. 7B).

The current paths for the other two phases A and C are equivalent, and all terminate on the same star connection S. It will be appreciated that the sum of currents at the “neutral” star point is always zero. That is, the current flowing from a particular phase returns via the other phases.

Whilst FIGS. 7A and 7B illustrate how the current flows through an exemplary stator between the different coils, FIG. 7C illustrates how the current flows within a coil, through the adjacent conductive elements. In FIG. 7C, a current path is shown through a set of conductive coils (four conductive elements), one coil in the first stator portion 719 and one coil in the second stator portion 721, from the first busbar B1 to the second busbar B2.

From the first busbar B1, the current enters the first conductive element of the first coil, arrow 801a, for example through a tail portion 128. The current then passes through each winding of the first conductive element, passing through the two “Core” sections, or active sections 121a, 121b. The current will pass through each active section 121a, 121b multiple times (equal to the number of winding turns in the conductive element), arrow 803a. After passing through each winding of the active sections 121a, 121b, the current then passes from the end of the first conductive element and into the second conductive element (within the same coil as the first, however), arrows 805a and 807. The current then passes into the active sections 121a, 121b (arrow 801b) and then through the active sections 121a, 121b of the second conductive element a number of times equal to the number of winding turns, arrow 803b. Once the current has passed through all of the winding turns in the active sections 121a, 121b in the second conductive element of the first coil, the current then leaves the first coil at the “Upper” portion (arrow 805b) and then passes to the second coil (arrow 809).

It should be noted that whilst arrow 809 passes directly from the first coil to the second coil, the current actually passes between the first coil and the second coil via the jumpers (e.g., arrows 705a, 705b in FIG. 7A). Arrow 809 has been illustrated in such a manner in FIG. 7C so as not to obscure the path of the current within the coils themselves.

Upon entering the first conductive element of the second coil at the “Lower” portion, the current passes to the active sections 121a, 121b of the first conductive element of the second coil (arrow 811a). The current then passes through the active sections 121a, 121b a number of times equal to the number of winding turns, arrow 813a, before leaving the first conductive element of the second coil to enter the second conductive element of the second coil (along arrows 815a and 817). The current then passes into the active sections 121a, 121b (arrow 811b) and then through the active sections 121a, 121b of the second conductive element a number of times equal to the number of winding turns, arrow 813b. Once the current has passed through all of the windings in the active sections 121a, 121b in the second conductive element of the second coil, the current then leaves the second coil at the “Upper” portion (arrow 815b), passing to the second busbar B2.

When viewed axially, in one stator portion the current progresses in a clockwise direction between conductive elements whilst in the other stator portion the current progresses in an anticlockwise direction. For the avoidance of confusion, it is also noted that whilst the current may progress between conductive elements in opposite directions in the first and second stator portions, the current will flow in the same radial direction along circumferentially aligned active sections in the two stator portions. For example, as illustrated in FIG. 7C, in the first stator portion 719 the current passes through the left conductive element of the first coil first and then the right conductive element and in the second stator portion 721, the current passes through the right conductive element of the second coil first and then the left conductive element. In other words, the first conductive element of the first coil is the left conductive element and the second conductive element of the first coil is the right conductive element, whereas the first conductive element of the second coil is the right conductive element and the second conductive element of the second coil is the left conductive element. In this sense, the terms “first” and “second”, when applied to the conductive coils when describing FIGS. 7A-7D, relate to their relative order along the current path. It will be appreciated that the terms left and right are used in reference to the position of the conductive elements in the schematic diagram of FIG. 7A.

It should be noted that the capital and lower case letters in FIGS. 7A and 7C refer to the direction of current flowing through an active section, or equivalently whether the active section is a “first” (e.g., 121a) or a “second” (e.g., 121b) active section within that stator portion. That is, as can be seen in FIGS. 5E and 5F, and FIGS. 6A to 6D, for example, when the conductive elements are stacked together, current will flow in opposite directions along the first and second active sections of each conductive element, and the conductive elements are arranged such that all of the first active sections of a stator portion are at one level in the stator (e.g., a first distance from the first end of the stator) and all of the second active section of a stator portion are at a different level in the stator (e.g., a second distance from the first end of the stator, the second distance being different from the first distance). For example, in FIGS. 7A and 7C a capital letter may refer to a first active section (e.g., with current flowing radially inwards for a given direction of magnetic field when in use) and a lower case letter may refer to a second active section (e.g., with current flowing radially outward for a given direction of magnetic field when in use).

FIGS. 7A to 7C illustrate one possible connection scheme for the case of two poles. However, more poles may be present. In this case, the first and/or second busbars may comprise a number of distinct busbar portions that can connect up (electrically) adjacent poles in series. For example, the second coil of a first pole may be connected to the second coil of a second pole by a first portion of the second busbar. The first coil of the second pole may be connected to the first coil of a third pole by a first portion of the first busbar. The second coil of the third pole may be connected to the second coil of a fourth pole by a second portion of the second busbar, and so on. It will be appreciated that this method of connection can be expanded to fit any number of poles.

As well as being connected in series, coils or poles may be connected in parallel. For example, the first pole may be connected in parallel with a second and third pole by having the first coil of each pole connect to the first busbar and then the second coil of each pole connect to the second busbar (the first and second busbars not being divided up into portions as in the example above). In this case, the second busbar is a star connection to which each phase connects.

A schematic illustration of such a stacked-winding stator is shown in FIG. 7D. The stacked-winding stator of FIG. 7D is configured for use with a three phase power supply. The components relating to different phases are illustrated with different types of line. The components carrying the first phase are drawn in a dotted line, the components carrying the second phase are drawn in a dashed line, and the components carrying the third phase are drawn in a solid line. The star connection S, which is common to each phase, is drawn with an alternating dot-dash line.

The stacked-winding stator comprises a first busbar arrangement 723, comprising a first busbar A1, B1, C1 for each phase disposed at a first axial end of the stacked-winding stator and a star connection S disposed at a second axial end of the stacked-winding stator. The coils of the stator are arranged in the first stator portion 719 and the second stator portion 721. Connectors 727, or jumpers 727, are provided between the second stator portion 721 and the start connection S for electrically connecting the first stator portion 719 and the second stator portion 721.

Two poles P1, P2 are illustrated, and, for each phase, the poles P1, P2 comprises a coil in the first stator portion 719 and the second stator portion 721. Each coil in the first stator portion 719 and the second stator portion 721 is represented by a box, such as coils 719a, 721a. The coils comprise one or more conductive elements connected in series, though the conductive elements themselves are not illustrated.

A representative current path begins at the first busbar A1, passes into the coil 719a of the first stator portion 719, then, via the connector 727a, into the coil 721a of the second stator portion 721, before entering the star connection S. It will be appreciated that this current path is repeated, for each phase, in parallel between the first busbar arrangement 723 and the star connection S. It will also again be appreciated that the sum of currents at the “neutral” star point is always zero. That is, the current flowing from a particular phase returns via the other phases.

Different combinations of series and parallel connections may be used depending upon the required use case. For example, it has been found that for low voltage (and high current) applications it is advantageous for the coils in the two stator portions to be connected in parallel, whilst the different poles within each stator portion can be optionally connected in series. On the other hand, for high voltage (and low current) applications, it has been found preferable to connect the coils in the two stator portions in series.

Furthermore, each stator portion need not necessarily have the same configuration. For example, different stator portions may have different coil spans (the angle γ by which the two active sections 121a, 121b of a conductive element are pitched apart). This means different stator portions can have different amounts of short chording (including one having short chording and another having none). Different stator portions may also have different winding factors, which can improve the fundamental harmonics of the electric machine.

The connections to the connectors/jumpers and to the busbars can be made using the terminal portions or tails of the coils, e.g. terminal portions 128 in FIGS. 5A-5D and 6A-6D. Depending upon the connection pattern used, coils with different arrangements of terminal portions may be needed. For example, some coils may be needed with both terminal portions extending in different axial directions (as illustrated in FIGS. 6A-6D), whilst in other cases coils may be needed with terminal portions extending in the same axial direction. Furthermore, the length of the terminal portions will be dependent upon whether they are to be connected to the first or second busbar arrangements, and whether the coil is to be located in the first or second stator portions.

For example, consider the case where the coils are connected as disclosed in FIG. 7A. The first coil of the first pole (i.e. the coil having the current path represented by line 703) requires connections to the first busbar B1 at the first axial end (located at the bottom of FIG. 7A) and to the connector (jumper) at the second axial end (the top of FIG. 7A). The connection to the first busbar B1 is at a lower portion of the stator portion, whilst the connection to the connector is from an upper portion. Hence, the first terminal portion (connecting to the first busbar) thus needs to extend in the opposite direction to the second terminal portion (connecting to the jumper). Additionally, whilst the first terminal portion only needs to extend a short distance from the first stator portion to the first busbar, the second terminal portion is required to extend from the first stator portion beyond the second stator portion to connect to the jumpers at the second end. The second terminal portion is therefore required to be of sufficient length, and must also be appropriately positioned and shaped so as not to interfere with the second stator portion.

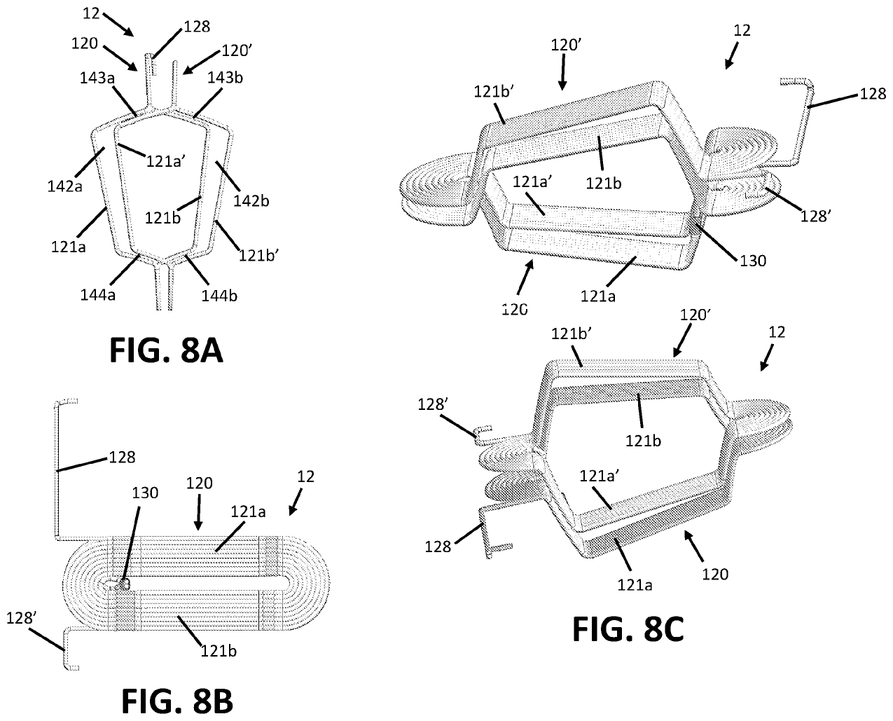

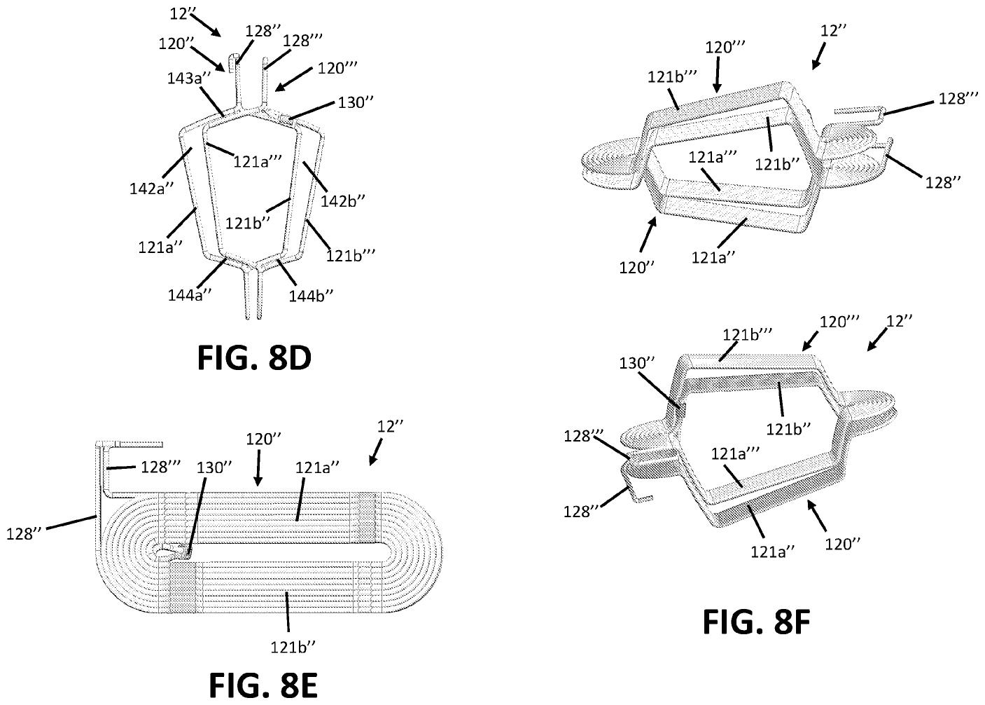

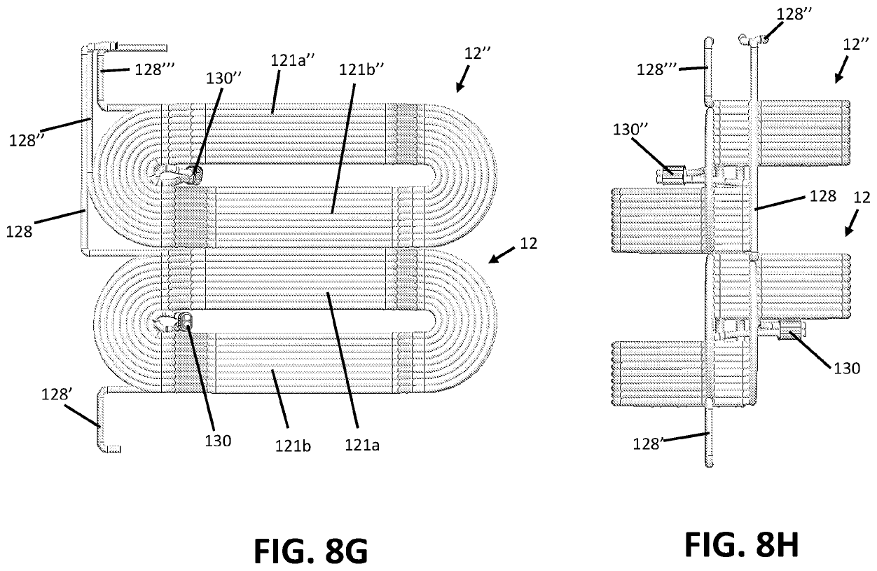

Such a coil 12 is represented in FIGS. 8A, 8B and 8C. Generally, the coil is similar to that illustrated in FIGS. 6A-6D, and has been labelled with corresponding reference numerals for aspects that are the same. With reference to the position of the coil when in a stator portion, FIG. 8A illustrates a view along a direction parallel to the axis of the stator portion (i.e., a plan view of the coil), FIG. 8B illustrates a view along a circumferential direction of the stator portion (i.e., a side view of the coil), whilst FIG. 8C illustrates two perspective views of the coil. As with the coil of FIGS. 6A-6D, in the coil of FIGS. 8A-8C the terminal portions 128, 128′ extend in opposite directions, such that, when assembled into a stator, one terminal portion 128 extends towards one end of the stator (e.g., a second axial end) and the other terminal portion 128′ extends towards another end of the stator (e.g., a first axial end). The terminal portions 128, 128′ also both extend from the outer portion of the coil. A difference compared to the coil illustrated in FIGS. 6A-6D, however, is that the terminal portion 128 extends much further than terminal portion 128′ axially (parallel to the axis of rotation when part of an electric machine). This enables the terminal portion 128, when the coil is positioned in the first stator portion, to extend beyond the second stator portion to contact the connectors at the second axial end of the stator, which are on the opposite side of the second stator portion to the first stator portion. It will also be noted that, in order to bypass the second stator portion in this manner, the terminal portion 128 extends, in a radial direction, beyond the outer edge of the body of the coil. This can be best seen in the side view of the coil shown in FIG. 8B. This enables the terminal portion 128 to pass radially outside of a circumferentially aligned coil in the second stator portion to contact the connectors.

With respect to the second coil of the first pole (i.e. the coil in the second stator portion having the current path represented by line 707), this coil requires a different arrangement of terminal portions. In this case, both terminal portions are required to extend in the same direction—towards the second axial end to connect to the connectors 727 and the second busbar B2, as illustrated in FIG. 7A. In some cases, they will also need to be similar lengths, though this will depend upon how the second busbar and jumpers are arranged relative to one another and from exactly where the terminal portions extend from the coil. FIGS. 8D, 8E and 8F illustrate one exemplary coil 12″. As with FIGS. 8A-8C, FIG. 8D illustrates a plan view of the coil, FIG. 8E illustrates a side view and FIG. 8F illustrates two perspective views. Generally, the coil is similar to that illustrated in FIGS. 8A-8C, and has been labelled with corresponding reference numerals. As can be seen, both terminal portions are disposed at an outer portion of the coil (i.e., a portion that will be at an outer radius of a stator portion once assembled). However, in FIGS. 8D-8F, the terminal portions 128″, 128″' both extend in the same axial direction.

FIGS. 8G and 8H show how coil 12, illustrated in FIGS. 8A-8C, and coil 12″, illustrated in FIGS. 8D-8F, can be arranged with respect to one another to allow connection to the required connectors and busbars, when each coil 12, 12″ is arranged in its respective stator portion. That is, an arrangement of the coils is shown when coil 12 is positioned in the first stator portion and coil 12″ is a circumferentially aligned coil in the second stator portion. In particular, it can be seen in FIGS. 8G and 8H how the tail 128 extends radially outwards in order that it can pass from coil 12 outside coil 12″ and tail 128″ to connect a connector (which would be positioned above the coils in the illustrated view). It can also be seen how tails 128 and 128″ each have a bent portion such that, although their axially extending portions are both circumferentially in line with each other (i.e., they both lie on the same radial line but at different distances from the centre of the stator), they can both connect to the required busbars and connectors.

### Machine Efficiency

Axial flux machines 100 comprising the stator assembly 1 described herein have been found to provide not only a high peak efficiency, but a high efficiency over a broad range of operating parameters. While high peak efficiencies are often quoted, they are in practice rarely achieved, especially in applications where the machine is required to perform over a range of operating parameters. Efficiency over a broad range of parameters is therefore a more practically meaningful measure for many applications.

There may be a number of different reasons for the high efficiencies which the stator assembly 1 is able to achieve. Some of these will now be described.

First, as explained above, the almost self-forming structure of the conductive components of the stator portion 10 that is provided by the geometry of the coils 12 allows for the very accurate placement of components of the stator core. The accurate placement of the components of the core means that there is better coupling of the stator and rotor fields, and a high degree of symmetry around the circumference of the stator which improves the generation or torque.

Another significant advantage is the generation of a stator field with a more accurately sinusoidal magnetic flux density. As will be understood by those skilled in the art, the higher the number of slots per pole per phase in the stator, the more sinusoidal the magnetic flux density can be. The coils 12 and stator portion 10 described above can provide an increased number of slots per pole per phase by increasing the number of conductive elements 120 per conductive coil 12, and this number can easily be scaled up (if, for example, the radius of the stator can be increased for a particular application). An advantage of a highly sinusoidal magnetic flux density is that the flux density has a relatively low harmonic content. With a low harmonic content, more of the coupling the rotor and stator fields involves the fundamental components of the flux density, and less involves the interaction with the harmonic components. This reduces the generation of eddy currents in the rotor magnets, which in turn reduced losses due to heating. In contrast, many known axial flux motors utilize a concentrated winding arrangement which only provides for a limited number (e.g. fractional) slot per pole per phase, which generates a much more trapezoidal flux density with more significant harmonic components.

While the coils 12 can be implemented using axially extending strips, they are preferably implemented using axially stacked winding arrangement illustrated in FIGS. 5A-5D and 6A-6D. While many motor manufacturers may consider this a disadvantage because it may be considered to reduce the fill factor in the stator core, the inventors have found this disadvantage is compensated for by the reduction in the skin and proximity effects which causes currents to flow in the outer region of the conductor cross-section and predominantly for those conductors in the axially-outer portions of the active sections. The number of winding turns in the axial direction may be selected to balance these two considerations.

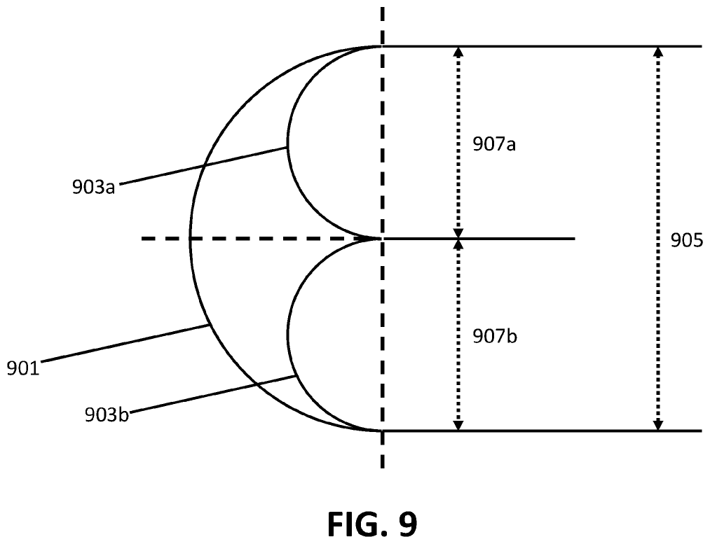

A further particular benefit of the use of the stacked-winding stator disclosed herein is the reduction in the amount of copper (or other material) used in the end portions of the coils—that is, less material is used to connect the active sections. This is illustrated in FIG. 9.

Semicircle 901 represents the area of material (and hence can be taken as a proxy for the volume of material) used connecting the active sections if only one stator portion is used, whilst semicircles 903a and 903b represent the areas used if two stator portions are used. It can be seen that the total area is greatly less, for the same width of active section (lines 907a and 907b have the same total length as line 905). This means that the amount of material needed can be reduced without reducing the power generated by the motor. Indeed, given that the radii of semicircles 903a and 903b are half that of semicircle 901, the amount of material required to connect the active sections when two stator portions are used is only one half of that needed for one stator portion. This provides both a cost saving as well as an important weight saving, which, for example, could help increase the range of an electric vehicle powered by a motor incorporating such a stator.

Described above are a number of embodiments with various optional features. It should be appreciated that, with the exception of any mutually exclusive features, any combination of one or more of the optional features are possible.

1.-25. (canceled)

26. A stacked-winding stator for an axial flux electrical machine configured for use with a multi-phase power supply, the stacked-winding stator comprising:
a first stator portion comprising a first plurality of conductive coils; and
a second stator portion comprising a second plurality of conductive coils;
wherein each conductive coil in the first plurality of conductive coils and the second plurality of conductive coils comprises at least one pair of active sections, wherein each active section extends in a generally radial direction substantially perpendicular to an axis of rotation of the electrical machine;
wherein the first stator portion and the second stator portion are axially aligned and each comprise spaces between adjacent active sections for receiving flux guides, the spaces in the first stator portion being circumferentially aligned with the spaces in the second stator portion; and
wherein each conductive coil in the first plurality of conductive coils has a corresponding conductive coil in the second plurality of conductive coils electrically connected to it to form a set of conductive coils.

27. The stacked-winding stator of claim 26, wherein circumferentially aligned spaces in the first stator portion and the second stator portion are configured to receive a common flux guide.

28. The stacked-winding stator of claim 27, further comprising a flux guide positioned within each set of aligned spaces.

29. The stacked-winding stator of claim 26, wherein the active sections of each pair of active sections are pitched apart in a circumferential direction, and wherein circumferentially adjacent conductive coils circumferentially overlap.

30. The stacked-winding stator of claim 26, wherein the spaces include spaces of a first type, each space of the first type being a circumferential space between two adjacent active sections of two different conductive coils.

31. The stacked-winding stator of claim 26, wherein each conductive coil comprises a plurality of pairs of active sections connected to each other in series, wherein adjacent pairs of active sections circumferentially overlap and wherein the spaces include spaces of a second type, each space of the second type being a circumferential space between two adjacent active sections of the same conductive coil but different pairs of active sections of the conductive coil.

32. The stacked-winding stator of claim 31, wherein the plurality of pairs of active sections of each conductive coil are either integrally formed or formed by connecting, in series, a plurality of separate elements which each comprise one pair of active sections.

33. The stacked-winding stator of claim 31, wherein, in use, current flows in the same direction along adjacent active sections separated by one of the spaces of the second type.

34. The stacked-winding stator of claim 26, wherein, in use, current flows in opposite radial directions along the active sections of each pair of active sections of each conductive coil.

35. The stacked-winding stator of claim 26, wherein the active sections of each pair of active sections are axially offset from each other.

36. The stacked-winding stator of claim 26, wherein each active section comprises a plurality of axially and/or circumferentially stacked winding turning portions; and
wherein the respective active sections in each conductive coil for each set of conductive coils are aligned with one another in a circumferential direction.

37. The stacked-winding stator of claim 26, wherein the respective active sections in each conductive coil for each set of conductive coils are offset from one another in a circumferential direction by an integer number of spaces.

38. The stacked-winding stator of claim 26, such that for an N phase power supply each conductive coil in each set of conductive coils are connected to the same phase.

39. The stacked-winding stator of claim 38, wherein the stacked-winding stator comprises a plurality of poles, each pole comprising an integer M multiple of N sets of conductive coils, with M sets of conductive coils for each phase.

40. The stacked-winding stator of claim 38, wherein for each set of conductive coils the conductive coil in the first plurality of conductive coils is connected in series to the conductive coil in the second plurality of conductive coils by a connector.

41. The stacked-winding stator of claim 40:
wherein the stacked-winding stator further comprises a first busbar arrangement and a second busbar arrangement, the first busbar arrangement comprising a first busbar for each phase and a star connection and the second busbar arrangement comprising a second busbar for each phase, and
wherein for each of the N phases:
each conductive coil from the first plurality of conductive coils in a first set of conductive coils in a first pole is connected to the first busbar for the respective phase, and each conductive coil from the first plurality of conductive coils in a last set of conductive coils in a last pole is connected to the star connection of the first busbar arrangement; and
each conductive coil from the second plurality of conductive coils is connected to the second busbar for the respective phase, such that a current path is formed from the first pole to the last pole via the sets of conductive coils and the second busbar for the respective phase.

42. The stacked-winding stator of claim 26, wherein for each set of conductive coils the conductive coil in the first plurality of conductive coils is connected in parallel to the conductive coil in the second plurality of conductive coils by one or more connectors.

43. An electric machine configured for use with a multi-phase power supply, the electric machine comprising:
a stacked-winding stator for an axial flux electrical machine configured for use with a multi-phase power supply, the stacked-winding stator comprising:
a first stator portion comprising a first plurality of conductive coils; and
a second stator portion comprising a second plurality of conductive coils;
wherein each conductive coil in the first plurality of conductive coils and the second plurality of conductive coils comprises at least one pair of active sections, wherein each active section extends in a generally radial direction substantially perpendicular to an axis of rotation of the electrical machine;
wherein the first stator portion and the second stator portion are axially aligned and each comprise spaces between adjacent active sections for receiving flux guides, the spaces in the first stator portion being circumferentially aligned with the spaces in the second stator portion; and
wherein each conductive coil in the first plurality of conductive coils has a corresponding conductive coil in the second plurality of conductive coils electrically connected to it to form a set of conductive coils;
the electric machine further comprising:
a first rotor portion disposed at a first axial end of the stacked-winding stator; and
a second rotor portion disposed at a second axial end of the stacked-winding stator.

44. A conductive coil comprising at least one pair of active sections, a first terminal portion and a second terminal portion;
wherein the first terminal portion is configured to extend axially in the first direction for connection to the first busbar arrangement; and
wherein the second terminal portion is configured to extend axially in the second direction for connection to a connector, the second terminal portion having an extended portion configured to extend beyond the second stator portion in the second direction; and
wherein the conductive coil is for use in a first stator portion of a stacked-winding stator for an axial flux electrical machine configured for use with a multi-phase power supply, the stacked-winding stator comprising a first stator portion comprising a first plurality of conductive coils and a second stator portion comprising a second plurality of conductive coils;
wherein the active sections are configured to extend in a generally radial direction substantially perpendicular to an axis of rotation of the electrical machine;
wherein the first stator portion and the second stator portion are axially aligned and each comprise spaces between adjacent active sections for receiving flux guides, the spaces in the first stator portion being circumferentially aligned with the spaces in the second stator portion; and
wherein each conductive coil in the first plurality of conductive coils has a corresponding conductive coil in the second plurality of conductive coils electrically connected to it to form a set of conductive coils.

45. A conductive coil comprising at least one pair of active sections, a first terminal portion and a second terminal portion;
wherein the first terminal portion is configured to extend axially in the second direction for connection to the second busbar arrangement; and
wherein the second terminal portion is configured to extend axially in the second direction for connection to a connector; and
wherein the conductive coil is for use in a second stator portion of a stacked-winding stator for an axial flux electrical machine configured for use with a multi-phase power supply, the stacked-winding stator comprising a first stator portion comprising a first plurality of conductive coils and a second stator portion comprising a second plurality of conductive coils;
wherein the active sections are configured to extend in a generally radial direction substantially perpendicular to an axis of rotation of the electrical machine;
wherein the first stator portion and the second stator portion are axially aligned and each comprise spaces between adjacent active sections for receiving flux guides, the spaces in the first stator portion being circumferentially aligned with the spaces in the second stator portion; and
wherein each conductive coil in the first plurality of conductive coils has a corresponding conductive coil in the second plurality of conductive coils electrically connected to it to form a set of conductive coils.
